(19) United States
(12) Patent Application Publication
(10) Pub. No.: US 2026/0122301 A1
(43) Pub. Date: Apr. 30, 2026

(54) IMAGE PROCESSING SYSTEM, IMAGE PROCESSING APPARATUS, AND IMAGE PROCESSING METHOD

(71) Applicant: Sony Group Corporation, Tokyo (JP)

(72) Inventors: Mitsuru KATSUMATA, Tokyo (JP); Mitsuhiro HIRABAYASHI, Tokyo (JP)

(73) Assignee: Sony Group Corporation, Tokyo (JP)

(21) Appl. No.: 18/692,337

(22) PCT Filed: Jan. 28, 2022
(86) PCT No.: PCT/JP2022/003345

§ 371 Date: Mar. 15, 2024

(30) Foreign Application Priority Data
Oct. 5, 2021 (JP) 2021-164271

(51) Int. Cl. H04N 21/2662; H04N 21/231; H04N 21/234; H04N 21/239

(52) U.S. Cl. CPC H04N 21/2662; H04N 21/231; H04N 21/23418; H04N 21/2393

(57) ABSTRACT

There is provided an image processing system, an image processing apparatus, and an image processing method capable of suppressing an increase in a processing load of a client while suppressing an increase in a processing load of a server. A client apparatus requests a server to transmit a bitstream of a partial region on the basis of partial region file generation information included in a control file, the server generates the bitstream of the partial region constituted by some subpictures included in a picture on the basis of a request from the client apparatus and transmits the bitstream to the client apparatus, and the client apparatus receives the bitstream of the partial region and segments a segmented region. The present disclosure can be applied to, for example, an image processing system, an image processing apparatus, an electronic device, an image processing method, a program, and the like.

### TECHNICAL FIELD

The present disclosure relates to an image processing system, an image processing apparatus, and an image processing method, and more particularly, to an image processing system, an image processing apparatus, and an image processing method capable of suppressing an increase in a processing load of a client while suppressing an increase in a processing load of a server.

### BACKGROUND ART

Conventionally, in Versatile Video Coding (VVC) of a standard specification of an image coding scheme, each picture can be divided into one or more subpictures (see, for example, Non-Patent Document 1). Furthermore, as a scheme of storing a picture file encoded by the VCC, a VVC file format using International Organization for Standardization Base Media File Format (ISOBMFF) which is a file container specification of an international standard technology, Moving Picture Experts Group-4 (MPEG-4) for moving image compression has been developed (see, for example, Non-Patent Document 2 to Non-Patent Document 4).

By the way, for example, there is content in which a partial region is segmented from a large picture, such as a 360-degree video that can be viewed in all directions, and reproduced (displayed). In that case, a method in which a server distributes data of the entire picture and a client apparatus segments a partial region from the picture and displays the partial region, and a method in which the server segments a partial region from the picture and distributes a segmented image to the client apparatus have been considered.
Non-Patent Document 1: Benjamin Bross, Jianle Chen, Shan Liu, Ye-Kui Wang, “Versatile Video Coding (Draft 10)”, JVET-S2001-VH, Joint Video Experts Team (JVET) of ITU-T SG 16 WP 3 and ISO/IEC JTC 1/SC 29/WG 11 19th Meeting: by teleconference, 22 Jun.-1 Jul. 2020
Non-Patent Document 2:“Text of ISO/IEC FDIS 14496-15 6th edition Carriage of NAL unit structured video in the ISO Base Media File Format”, ISO/IEC JTC 1/SC 29/WG 11, N00234, 2021 May 31st
Non-Patent Document 3:“Information technology—Coding of audio-visual objects—Part 12:ISO base media file format”, ISO/IEC JTC 1/SC 29/WG 11, 2015 December
Non-Patent Document 4:“Information technology Dynamic adaptive streaming over HTTP (DASH)—Part 1: Media presentation description and segment formats”, ISO/IEC JTC 1/SC 29/WG 11, 2019 December

### SUMMARY OF THE INVENTION

### Problems to be Solved by the Invention

However, in the case of the method in which the client apparatus segments the partial region from the picture, the amount of data transmitted from the server to the client unnecessarily increases, and there is a possibility that a processing load of the client apparatus such as reception and decoding increases. Furthermore, processing of segmenting the partial region from the picture is also required so that there is a possibility that the processing load of the client apparatus further increases.

On the other hand, in the case of the method in which the server segments the partial region from the picture and distributes the partial region, the client apparatus receives and decodes data of an image smaller than the picture, so that the increase in the processing load of the client apparatus can be suppressed. However, the server needs to perform processing such as decoding, segmentation, and re-encoding, and there is a possibility that a processing load of the server increases.

The present disclosure has been made in view of such a situation, and aims to suppress an increase in a processing load of a client that reproduces content while suppressing an increase in a processing load of a server that distributes the content.

### Solutions to Problems

An image processing system according to one aspect of the present technology is an image processing system including a server and a client apparatus. The client apparatus requests the server for a bitstream of a partial region of a picture on the basis of partial region file generation information included in a control file for controlling distribution of a content file to generate a file for storing the bitstream of the partial region. The server generates the bitstream of the partial region constituted by some of subpictures among the subpictures included in the picture on the basis of the request by the client apparatus, and transmits the bitstream of the partial region to the client apparatus. The client apparatus receives the bitstream of the partial region transmitted from the server, and segments a segmented region from the bitstream of the partial region.

An image processing apparatus according to another aspect of the present technology is an image processing apparatus including: a generation unit that generates a bitstream of a partial region constituted by some of subpictures among the subpictures included in a picture on the basis of a request from another apparatus; and a transmission unit that transmits a bitstream of the partial region to the another apparatus.

An image processing method according to another aspect of the present technology is an image processing method including: generating a bitstream of a partial region constituted by some of subpictures among the subpicture included in a picture on the basis of a request from another apparatus; and transmitting the bitstream of the partial region to the another apparatus.

An image processing apparatus according to still another aspect of the present technology is an image processing apparatus including: a partial region file generation information generation unit that generates, on the basis of data of content, partial region file generation information for generating a file for storing a bitstream of a partial region of a picture; and a file generation unit that generates a control file for controlling distribution of a content file to store the partial region file generation information.

An image processing method according to still another aspect of the present technology is an image processing method including: generating partial region file generation information for generating a file for storing a bitstream of a partial region of a picture on the basis of data of content; and generating a control file for controlling distribution of a content file to store the partial region file generation information.

An image processing apparatus according to still another aspect of the present technology is an image processing apparatus including: a request processing unit that makes a request for a bitstream of a partial region of a picture on the basis of partial region file generation information included in a control file for controlling distribution of a content file to generate a file for storing the bitstream of the partial region; an acquisition unit that acquires the bitstream of the partial region; and a segmentation unit that segments a segmented region from the bitstream of the partial region.

An image processing method according to still another aspect of the present technology is an image processing method including: making a request for a bitstream of a partial region of a picture on the basis of partial region file generation information included in a control file for controlling distribution of a content file to generate a file for storing the bitstream of the partial region; acquiring the bitstream of the partial region; and segmenting a segmented region from the bitstream of the partial region.

In the image processing system according to one aspect of the present technology, the client apparatus requests the server for the bitstream of the partial region of the picture on the basis of the partial region file generation information included in the control file for controlling distribution of the content file to generate the file for storing the bitstream of the partial region, the server generates the bitstream of the partial region constituted by some of subpictures among the subpictures included in the picture on the basis of the request from the client apparatus, transmits the bitstream of the partial region to the client apparatus, and the client apparatus receives the bitstream of the partial region transmitted from the server, and segments the segmented region from the bitstream of the partial region.

In the image processing apparatus and method according to another aspect of the present technology, the bitstream of the partial region constituted by some of subpictures among the subpictures included in the picture is generated on the basis of the request from the another apparatus, and the bitstream of the partial region is transmitted to the another apparatus.

In the image processing apparatus and method according to still another aspect of the present technology, the partial region file generation information for generating the file for storing the bitstream of the partial region of the picture is generated on the basis of the data of content, the control file for controlling the distribution of the content file is generated, and the partial region file generation information is stored therein.

In the image processing apparatus and method according to still another aspect of the present technology, the bitstream of the partial region is requested on the basis of the partial region file generation information that is included in the control file for controlling the distribution of the content file to generate the file for storing the bitstream of the partial region of the picture, the bitstream of the partial region is acquired, and the segmented region is segmented from the bitstream of the partial region.

### BRIEF DESCRIPTION OF DRAWINGS

FIG. 1 is a diagram illustrating segmentation of an image.

FIG. 2 is a diagram illustrating an example of a content distribution method.

FIG. 3 is a diagram illustrating an example of a content distribution method.

FIG. 4 is a view illustrating a content distribution method.

FIG. 5 is a diagram illustrating a main configuration example of a content distribution system.

FIG. 6 is a block diagram illustrating a main configuration example of a file generation apparatus.

FIG. 7 is a block diagram illustrating a main configuration example of a distribution server.

FIG. 8 is a block diagram illustrating a main configuration example of a client apparatus.

FIG. 9 is a flowchart illustrating an example of a flow of file generation processing.

FIG. 10 is a flowchart illustrating an example of a flow of content distribution processing.

FIG. 11 is a flowchart illustrating an example of a flow of request processing.

FIG. 12 is a view illustrating an example of partial region file generation information.

FIG. 13 is a view illustrating an example of partial region file generation information.

FIG. 14 is a flowchart illustrating an example of a flow of track generation processing.

FIG. 15 is a flowchart illustrating an example of a flow of track generation processing.

FIG. 16 is a view illustrating an example of partial region file generation information.

FIG. 17 is a flowchart illustrating an example of a flow of track generation processing.

FIG. 18 is a view illustrating an example of partial region file generation information.

FIG. 19 is a flowchart illustrating an example of a flow of track generation processing.

FIG. 20 is a view illustrating a content distribution method.

FIG. 21 is a block diagram illustrating a main configuration example of a distribution server.

FIG. 22 is a flowchart illustrating an example of a flow of track generation processing.

FIG. 23 is a flowchart illustrating an example of a flow of track generation processing.

FIG. 24 is a flowchart illustrating an example of a flow of track generation processing.

FIG. 25 is a view illustrating an example of partial region file generation information.

FIG. 26 is a flowchart illustrating an example of a flow of track generation processing.

FIG. 27 is a view illustrating partial region information.

FIG. 28 is a view illustrating a description example of an MPD.

FIG. 29 is a diagram illustrating a configuration example of a picture and a partial region.

FIG. 30 is a flowchart illustrating an example of a flow of file generation processing.

FIG. 31 is a flowchart illustrating an example of a flow of content distribution processing.

FIG. 32 is a view illustrating a description example of an MPD.

FIG. 33 is a flowchart illustrating an example of a flow of file generation processing.

FIG. 34 is a view illustrating a description example of an MPD.

FIG. 35 is a flowchart illustrating an example of a flow of file generation processing.

FIG. 36 is a view illustrating a description example of an MPD.

FIG. 37 is a view illustrating an example of a sample group.

FIG. 38 is a view illustrating an example of RegionWisePackingStruct.

FIG. 39 is a flowchart illustrating an example of a flow of file generation processing.

FIG. 40 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. Reproduction of Segmented Region
2. Distribution of Partial Region
3. Extraction of Partial Region
4. Merge of Subpictures
5. Partial Region Information
6. Supplementary Note

### 1. Reproduction of Segmented Region

### Documents and the Like that Support Technical Contents and Technical Terms

The scope disclosed in the present technology includes, in addition to the contents described in the embodiments, contents described in the following Non-Patent Documents and the like known at the time of filing, contents of other documents referred to in the following Non-Patent Documents, and the like.
Non-Patent Document 1: (described above)
Non-Patent Document 2: (described above)
Non-Patent Document 3: (described above)
Non-Patent Document 4: (described above)

That is, the contents described in the above-described Non-Patent Documents, the contents of other documents referred to in the above-described Non-Patent Documents, and the like are also basis for determining the support requirement.

### Distribution of VVC Data

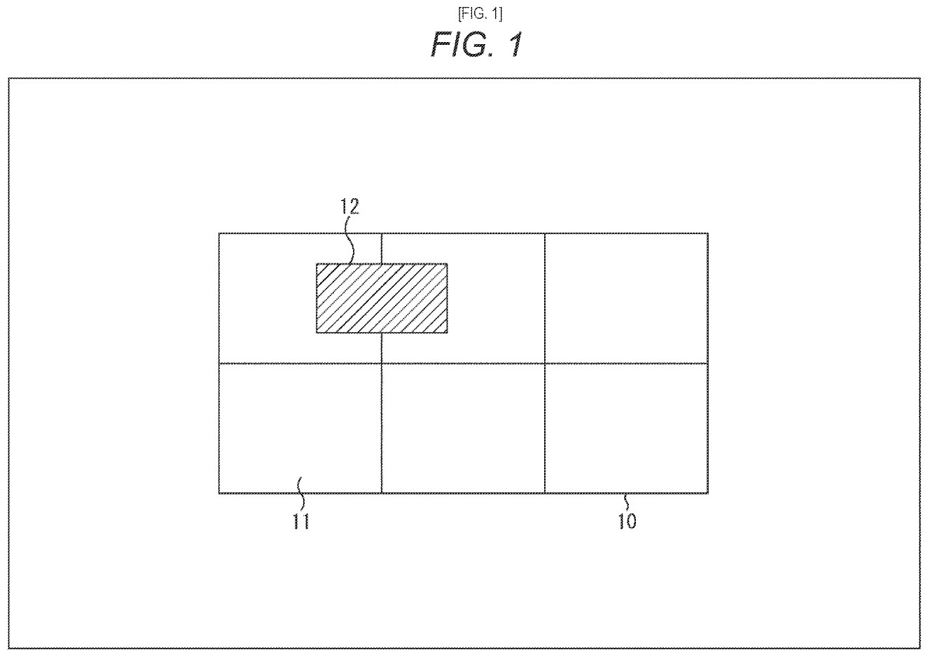

Conventionally, as described in Non-Patent Document 1, in Versatile Video Coding (VVC) of a standard specification of an image coding scheme, a bitstream of a picture can be divided into one or more subpictures without being decoded. For example, as illustrated in FIG. 1, a bitstream of a picture 10 can be divided into bitstreams for subpictures 11, respectively, without being decoded. For example, in the case of a 360-degree video, the bitstream of the picture 10 can be divided into bitstreams of six subpictures 11.

Furthermore, as a scheme of storing a picture file encoded by the VCC, a VVC file format using International Organization for Standardization Base Media File Format (ISOBMFF) which is a file container specification of an international standard technology, Moving Picture Experts Group-4 (MPEG-4) for moving image compression is developed as described in Non-Patent Document 2 to Non-Patent Document 4. Furthermore, adaptive streaming using DASH is possible.

By the way, for example, there is content in which a partial region is segmented from a large picture, such as a 360-degree video that can be viewed in all directions, and reproduced (displayed). For example, as illustrated in FIG. 1, there is content in which a segmented region 12, which is a partial region, is segmented from the picture 10, and the segmented region 12 is displayed as a display image.

In the case of distributing such content, a method in which a server transmits the bitstream of the entire picture 10 to a client apparatus, and the client apparatus segments the segmented region 12 from the picture 10 and displays the segmented region 12, and a method in which the server segments the segmented region 12 from the picture 10 and transmits a bitstream of the segmented region 12 to the client apparatus are considered.

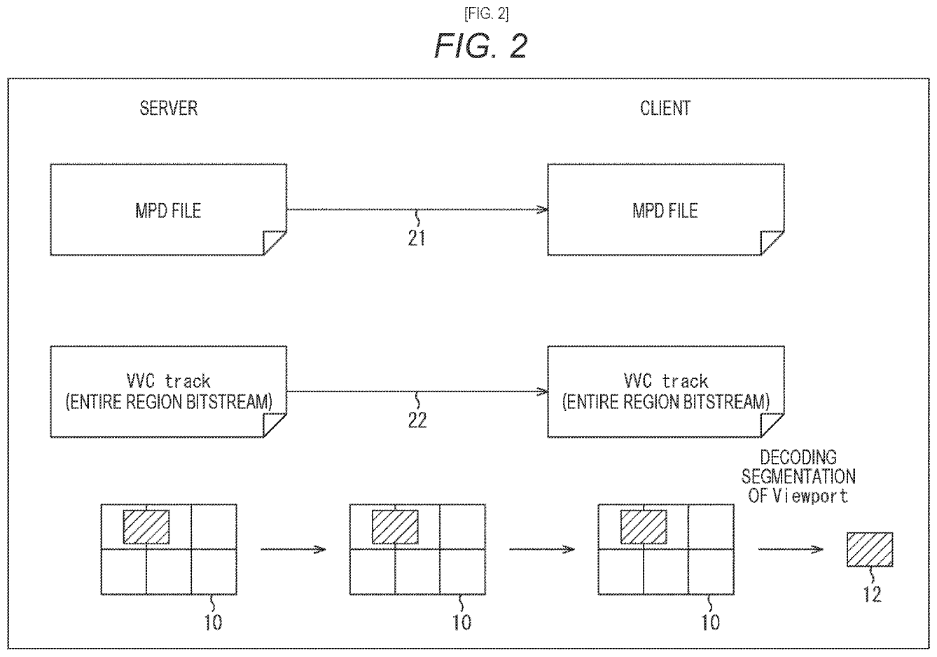

In the case of a method in which the client apparatus segments the segmented region 12 from the picture 10, the content is distributed in a procedure illustrated in FIG. 2, for example. First, a media presentation description (MPD) file is transmitted from the server to the client apparatus as indicated by an arrow 21. The MPD file is a control file that stores control information related to the content distribution. When the client apparatus requests the server to distribute the content on the basis of the MPD file, the server supplies the client apparatus with a content file (VVC track) of the requested content as indicated by an arrow 22. The VVC track stores the bitstream of the entire picture 10 encoded by VVC. The client apparatus extracts and decodes the bitstream of the picture 10 from the VVC track, and segments a desired segmented region 12 from the picture 10 and displays the segmented region 12 as a display region (Viewport).

That is, in the case of this method, there is a possibility that a transmission data amount unnecessarily increases since the bitstream of the entire picture 10 is transmitted from the server to the client apparatus. That is, data of a non-reproduced region in the picture 10 is also transmitted, which is inefficient. Therefore, there is a possibility that a processing load of the client apparatus increases. For example, the client apparatus receives the bitstream of the entire picture 10 so that there is a possibility that a processing amount and a buffer amount of reception processing increase. Furthermore, the client apparatus decodes the bitstream of the entire picture 10 so that there is a possibility that a processing amount and a buffer amount of decoding processing increase. Furthermore, a process of segmenting the segmented region 12 from picture 10 is required so that there is a possibility that the processing load of the client apparatus further increases.

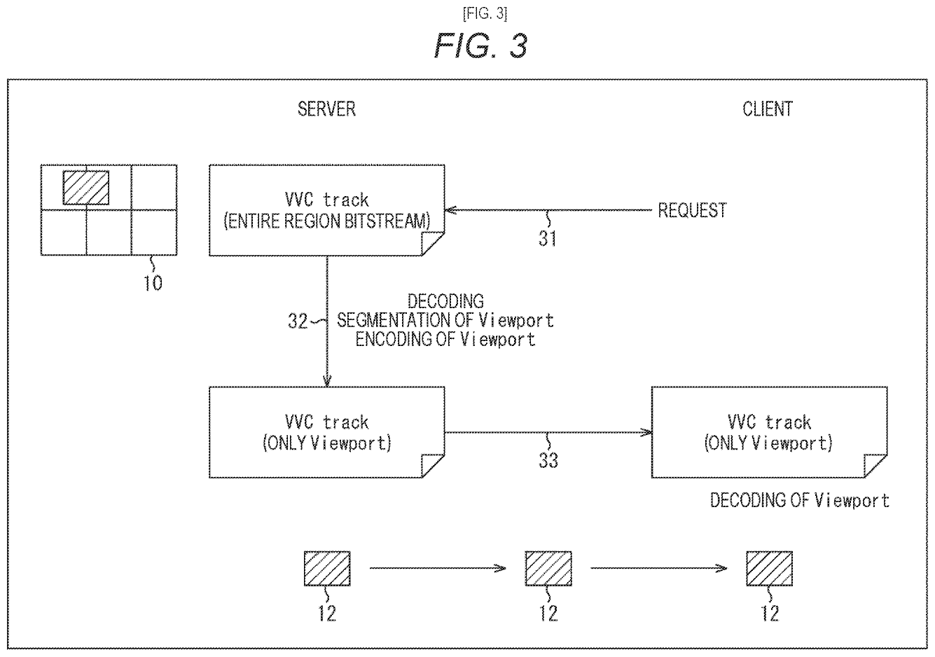

On the other hand, in the case of a method in which the server segments the segmented region 12 from the picture 10, content distribution is performed by, for example, a procedure illustrated in FIG. 3. As indicated by an arrow 31, when the client apparatus requests the distribution on the basis of a rule (for example, a query request using a Get method of HyperText Transfer Protocol (HTTP), or the like) independently stipulated by the client apparatus, the server decodes the bitstream of the entire picture 10 stored in a VVC track of the requested content, segments the requested segmented region 12 from the picture 10, and encodes data of the segmented region 12 to generate the bitstream of the segmented region 12 as indicated by an arrow 32. Then, the server stores the bitstream in a new content file (VVC track), and transmits the VVC track to the client apparatus as indicated by an arrow 33. The client apparatus decodes the bitstream of the segmented region 12 from the VVC track, and displays the segmented region 12 as a display region (Viewport).

That is, in the case of this method, the increase in the transmission data amount from the server to the client apparatus is suppressed since the bitstream of the segmented region 12 is transmitted. However, in the case of this method, the server needs to perform processing such as decoding of the bitstream of the picture 10, segmentation of the segmented region 12, and encoding of data of the segmented region 12, and there is a possibility that a processing load of the server increases. If a processing load for each client access increases, there is a possibility that the number of clients that can be simultaneously distributed by the server decreases. That is, there is a possibility that distribution performance of the server decreases and the maximum number of simultaneous connections decreases. Furthermore, there is a possibility that a delay time until content is distributed to the client apparatus increases as the processing load of the server increases. Moreover, a request from a client to the server is not standardized, and thus, needs to be stipulated independently, and there is no versatility.

### 2. Distribution of Partial Region

### Distribution of Partial Region including Subpictures

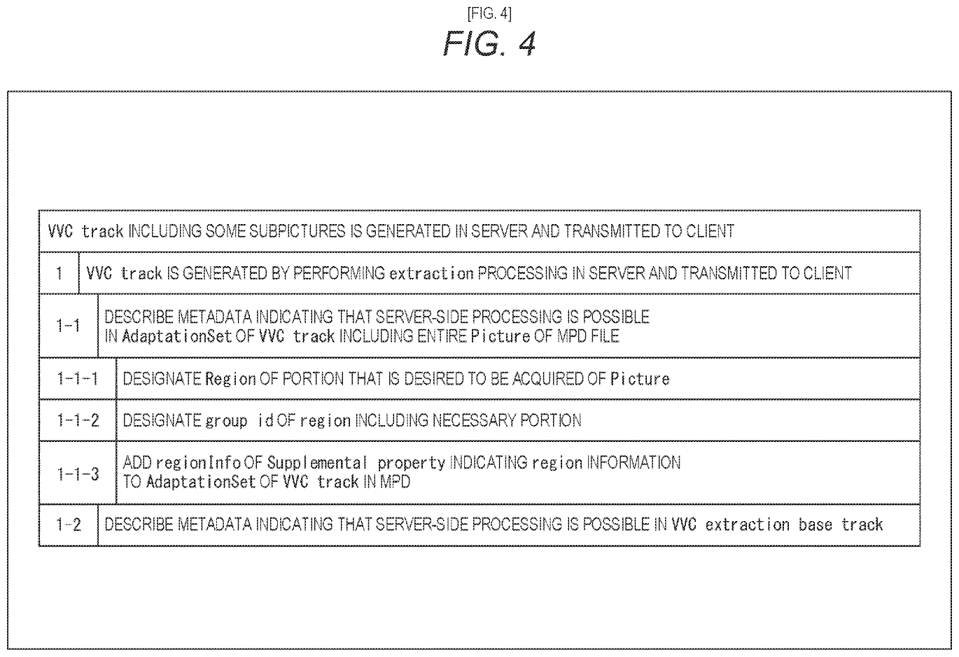

Therefore, as illustrated at the top row of the table in FIG. 4, a VVC track including some subpictures is generated in a server and transmitted to a client apparatus.

For example, in an image processing system including a server and a client apparatus, the client apparatus requests the server for a bitstream of a partial region of a picture on the basis of partial region file generation information included in a control file for controlling distribution of a content file to generate a file for storing the bitstream of the partial region, the server generates the bitstream of the partial region constituted by some of subpictures among the subpictures included in the picture on the basis of the request from the client apparatus, transmits the bitstream of the partial region to the client apparatus, and the client apparatus receives the bitstream of the partial region transmitted from the server, and segments a segmented region from the bitstream of the partial region.

In this manner, it is possible to suppress an increase in a processing load of a client that reproduces content while suppressing an increase in a processing load of the server that distributes the content.

### Content Distribution System

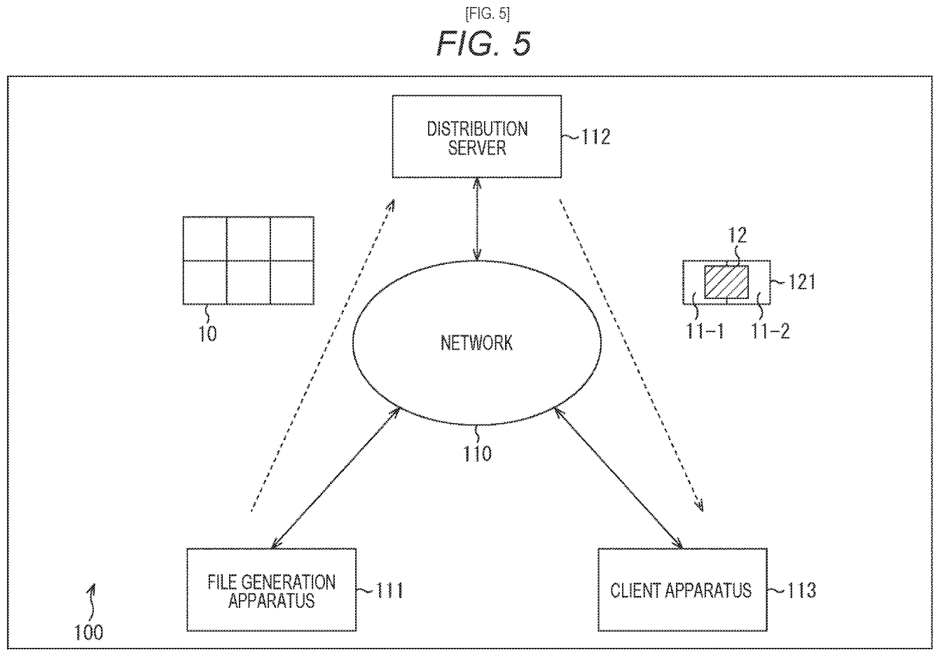

FIG. 5 is a diagram illustrating an example of a configuration of a content distribution system which is an aspect of an image processing system to which the present technology is applied. A content distribution system 100 illustrated in FIG. 5 is a system configured to distribute content including an image, and includes a file generation apparatus 111, a distribution server 112, and a client apparatus 113 as illustrated in FIG. 5.

The file generation apparatus 111, the distribution server 112, and the client apparatus 113 are connected to each other so as to be able to communicate via a network 110. The network 110 is a communication network serving as a communication medium between the respective apparatuses. The network 110 may be a communication network of wired communication, a communication network of wireless communication, or both of them. For example, the network 110 may be a wired local area network (LAN), a wireless LAN, a public telephone line network, a wide area communication network for a wireless mobile body such as a so-called 4G line or 5G line, the Internet, or the like, or a combination thereof. Furthermore, the network 110 may be a single communication network or a plurality of communication networks. Furthermore, for example, a part or all of the network 110 may be configured by a communication cable of a predetermined standard, such as a universal serial bus (USB) (registered trademark) cable, a high-definition multimedia interface (HDMI) (registered trademark) cable, or the like.

In FIG. 5, one file generation apparatus 111, one distribution server 112, and one client apparatus 113 are illustrated, but the number of these apparatuses is arbitrary.

The file generation apparatus 111 generates a content file (VVC track) that stores content distributed in the content distribution system 100. Furthermore, the file generation apparatus 111 generates an MPD file as a control file that stores control information for controlling distribution of the content. The file generation apparatus 111 transmits (uploads) the generated content file and MPD file to the distribution server 112.

The distribution server 112 performs processing related to content distribution. For example, the distribution server 112 acquires, stores, and manages the content file and MPD file supplied (uploaded) from the file generation apparatus 111. Furthermore, the distribution server 112 distributes the managed files to the client apparatus 113. For example, the distribution server 112 transmits the MPD file to the client apparatus 113 on the basis of a request from the client apparatus 113. When the client apparatus 113 requests distribution of the content file on the basis of the MPD file, the distribution server 112 transmits the content file (VVC track) to the client apparatus 113 in accordance with the request.

The client apparatus 113 performs processing related to reproduction of content distributed by the distribution server 112. For example, the client apparatus 113 requests an MPD file of desired content from the distribution server 112, and receives the MPD file transmitted in response to the request. Furthermore, the client apparatus 113 requests the distribution server 112 to distribute a content file on the basis of the MPD file. Then, the client apparatus 113 receives the content file (VVC track) transmitted in response to the request, extracts a bitstream from the content file, and decodes the bitstream to generate and display a display image.

In such a content distribution system 100, it is assumed that the client apparatus 113 displays the segmented region 12, which is a part of the picture 10, as a display region as in the example illustrated in FIG. 1. That is, it is assumed that client apparatus 113 displays an image of the segmented region 12 segmented from the picture 10.

Returning to FIG. 5, the file generation apparatus 111 encodes a moving image (the entire picture 10) by VVC to generate a bitstream of the picture 10. The file generation apparatus 111 stores the bitstream in a content file (VVC track). The file generation apparatus 111 uploads the content file to the distribution server 112.

Then, when the client apparatus 113 requests the distribution server 112 for a bitstream of a region including at least the segmented region 12, the distribution server 112 generates a bitstream of a partial region constituted by some subpictures including the segmented region 12, stores the bitstream in a new content file (VVC track), and transmits the bitstream to the client apparatus 113. For example, as illustrated in FIG. 5, in a case where the segmented region 12 is included in a partial region 121 constituted by a subpicture 11-1 and a subpicture 11-2, the distribution server 112 generates a bitstream of the partial region 121, stores the bitstream in a new content file (VVC track), and transmits the content file to the client apparatus 113.

The client apparatus 113 receives the VVC track in which the bitstream of the partial region 121 is stored. The client apparatus 113 extracts the bitstream of the partial region 121 from the VVC track. The client apparatus 113 decodes the extracted bitstream. Then, the client apparatus 113 segments an image of the segmented region 12 from an image of the partial region 121 obtained by the decoding, and displays the image as a display region.

In this manner, the bitstream of the partial region 121 is transmitted from the distribution server 112 to the client apparatus 113. That is, an increase in a transmission data amount can be suppressed as compared with a case where the bitstream of the picture 10 is distributed. Therefore, it is possible to suppress an increase in a processing load of the client apparatus as compared with the case of a method in which the client apparatus segments the segmented region 12 from the picture 10.

Furthermore, since the picture 10 is encoded by VVC, the bitstream can be divided into the subpictures 11 without being decoded. Therefore, the distribution server 112 can generate the bitstream of the partial region 121 more easily than the case of generating the bitstream of the segmented region 12. That is, it is possible to suppress an increase in a processing load of the server as compared with the case of a method in which the server segments the segmented region 12 from the picture 10. Therefore, a decrease in the maximum number of simultaneous connections and an increase in a delay time can be suppressed.

That is, the distribution server 112 that is an image processing apparatus includes: a generation unit that generates a bitstream of a partial region constituted by some of subpictures among the subpictures included in a picture on the basis of a request from another apparatus (for example, the client apparatus 113); and a transmission unit that transmits the bitstream of the partial region to the another apparatus.

Furthermore, in an image processing method, a bitstream of a partial region constituted by some of subpictures among the subpictures included in a picture is generated on the basis of a request from another apparatus, and the bitstream of the partial region is transmitted to the another apparatus.

In this manner, it is possible to suppress an increase in a processing load of a client while suppressing an increase in a processing load of a server.

Note that the distribution server 112 may generate a bitstream of the partial region 121 including subpictures on the basis of metadata for generating the bitstream of the partial region constituted by the subpictures. In this case, the file generation apparatus 111 may generate the metadata, store the metadata in a metadata file that stores the metadata, and upload the metadata file to the distribution server 112 together with the above-described content file (VVC track).

Furthermore, the client apparatus 113 may request a bitstream of a region including at least the segmented region 12 on the basis of partial region file generation information for generating a file that stores a bitstream of a partial region of the picture 10. For example, the client apparatus 113 may grasp a function of the distribution server 112 on the basis of the partial region file generation information included in an MPD file, and make a request by a method that can be handled by the distribution server 112. In this manner, the distribution server 112 can more reliably respond to the request. Note that the partial region file generation information may be generated by the file generation apparatus 111, stored in the MPD file, and uploaded to the distribution server 112.

Note that the partial region 121 is only required to be one partial region in the picture 10, be a region including the segmented region 12, and be a region constituted by the subpicture 11. That is, the number and arrangement of the subpictures 11 constituting the partial region 121 are arbitrary. For example, in the case of FIG. 5, the partial region 121 is constituted by two subpictures 11 (the subpicture 11-1 and the subpicture 11-2), but the partial region 121 may be constituted by one subpicture 11 or three or more subpictures 11. Furthermore, in the example of FIG. 5, the two subpictures 11 constituting the partial region 121 are arranged in the horizontal direction, but a plurality of subpictures 11 constituting a partial region may be arranged in the vertical direction, or may be arranged in the vertical direction and the horizontal direction. However, it is desirable that the partial region 121 be constituted by fewer subpictures 11 in order to further suppress an increase in a data transmission amount.

### File Generation Apparatus

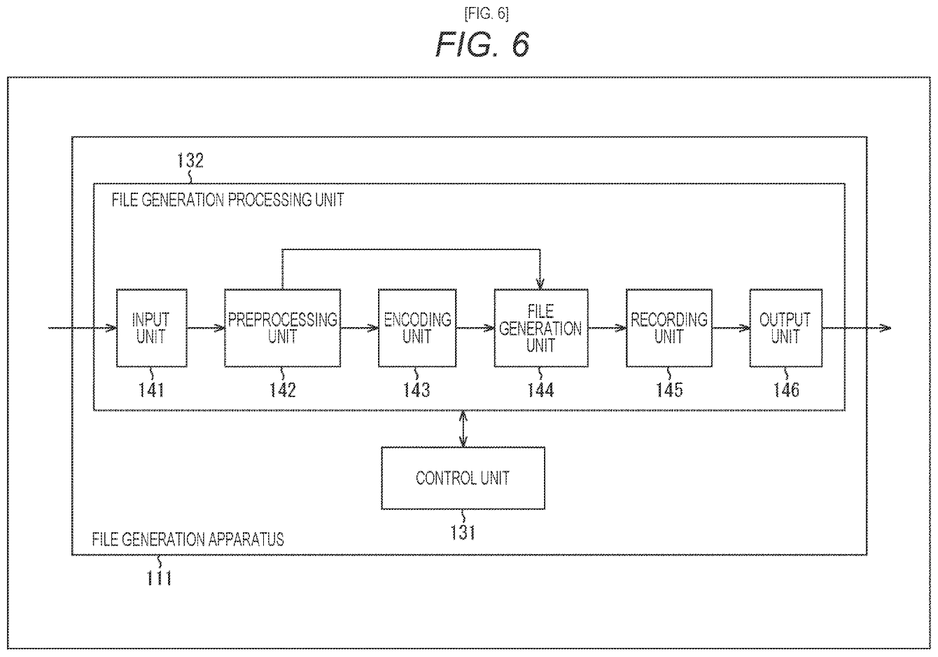

Next, the respective apparatuses of the content distribution system 100 will be described. FIG. 6 is a block diagram illustrating an example of a configuration of the file generation apparatus 111 that is an aspect of the image processing apparatus to which the present technology is applied.

Note that, in FIG. 6, main processing units, data flows, and the like are illustrated, and those illustrated in FIG. 6 are not necessarily all. That is, in the file generation apparatus 111, there may be a processing unit not illustrated as a block in FIG. 6, or there may be processing or a data flow not illustrated as an arrow or the like in FIG. 6.

As illustrated in FIG. 6, the file generation apparatus 111 includes a control unit 131 and a file generation processing unit 132. The control unit 131 controls the file generation processing unit 132. The file generation processing unit 132 is controlled by the control unit 131 and performs processing related to file generation.

The file generation processing unit 132 includes an input unit 141, a preprocessing unit 142, an encoding unit 143, a file generation unit 144, a recording unit 145, and an output unit 146.

The input unit 141 acquires data of content including a moving image and supplies the data to the preprocessing unit 142.

The preprocessing unit 142 generates partial region file generation information for generating a file that stores a bitstream of a partial region of the picture 10 of the moving image on the basis of the data of the content. The preprocessing unit 142 supplies the generated partial region file generation information to the file generation unit 144. That is, the preprocessing unit 142 can also be referred to as a partial region file generation information generation unit. Furthermore, the preprocessing unit 142 generates metadata for generating a bitstream of a partial region constituted by a subpicture on the basis of the data of the content. The preprocessing unit 142 supplies the generated metadata to the file generation unit 144. Moreover, the preprocessing unit 142 supplies the data of the content to the encoding unit 143.

The encoding unit 143 encodes the data of the content supplied from the preprocessing unit 142 to generate a bitstream. For example, the encoding unit 143 encodes the data of the moving image by VVC to generate a bitstream. That is, the encoding unit 143 generates a bitstream of the picture 10. The encoding unit 143 supplies the generated bitstream of the picture 10 to the file generation unit 144.

The file generation unit 144 acquires the bitstream of the picture 10 supplied from the encoding unit 143. Then, the file generation unit 144 generates a content file (VVC track) of ISOBMFF that stores the bitstream of the picture 10. That is, the file generation unit 144 generates the VVC track and stores the bitstream of the picture 10 in the VVC track. Furthermore, the file generation unit 144 acquires the metadata supplied from the preprocessing unit 142. The file generation unit 144 generates a metadata file and stores the metadata in the metadata file. Moreover, the file generation unit 144 acquires the partial region file generation information supplied from the preprocessing unit 142. Then, the file generation unit 144 generates an MPD file as a control file that stores control information for controlling content distribution, and stores the partial region file generation information in the MPD file. The file generation unit 144 supplies the generated files to the recording unit 145.

For example, the recording unit 145 includes an arbitrary recording medium such as a hard disk or a semiconductor memory, and records those files supplied from the file generation unit 144 in the recording medium. Furthermore, the recording unit 145 reads the files recorded in the recording medium in accordance with a request from the control unit 131 or the output unit 146 or at a predetermined timing, and supply the files to the output unit 146.

The output unit 146 transmits (uploads) the files read from the recording unit 145 to the distribution server 112 via the network 110.

### Distribution Server

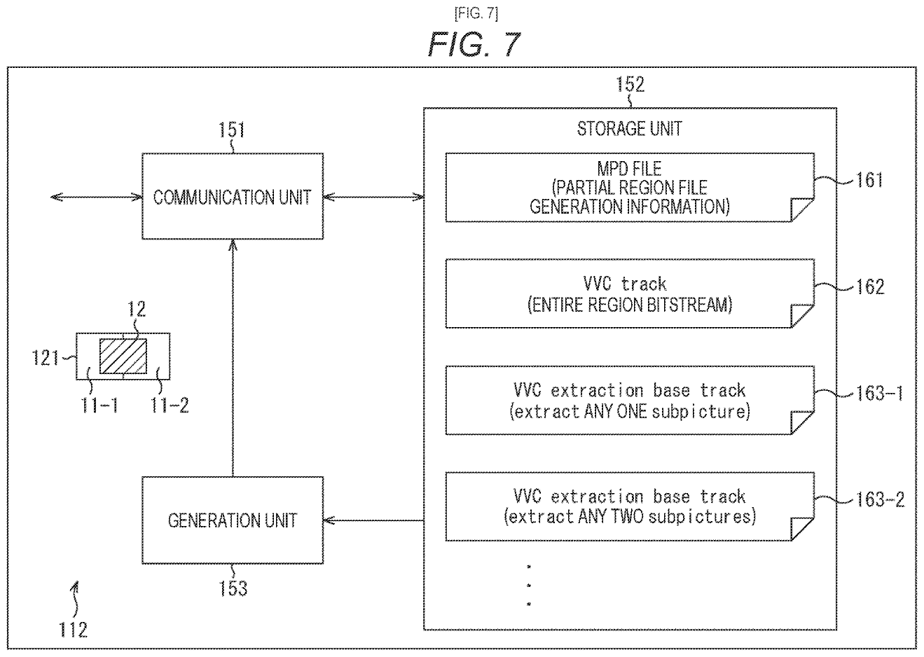

FIG. 7 is a block diagram illustrating an example of a configuration of the distribution server 112 which is an aspect of the image processing apparatus to which the present technology is applied.

Note that, in FIG. 7, main processing units, data flows, and the like are illustrated, and those illustrated in FIG. 7 are not necessarily all. That is, in the distribution server 112, there may be a processing unit not illustrated as a block in FIG. 7, or there may be a process or a data flow not illustrated as an arrow or the like in FIG. 7.

As illustrated in FIG. 7, the distribution server 112 includes a communication unit 151, a storage unit 152, and a generation unit 153.

The communication unit 151 communicates with another apparatus via the network 110. For example, the communication unit 151 communicates with another apparatus and acquires information from the another apparatus. For example, the communication unit 151 receives a content file (VVC track), a metadata file, an MPD file, or the like transmitted from the file generation apparatus 111. Furthermore, the communication unit 151 receives a request for the MPD file or the content file from the client apparatus 113. The communication unit 151 supplies the received content file (VVC track), metadata file, MPD file, or the like to the storage unit 152. Furthermore, the communication unit 151 supplies the received request to the generation unit 153. That is, the communication unit 151 can also be referred to as a reception unit.

Furthermore, for example, the communication unit 151 communicates with another apparatus and supplies information to the another apparatus. For example, the communication unit 151 reads an MPD file from the storage unit 152 and transmits the MPD file to the client apparatus 113. Furthermore, the communication unit 151 acquires a content file (VVC track) that stores a bitstream of the partial region 121 supplied from the generation unit 153, and transmits the content file to the client apparatus 113 which is another apparatus. That is, the communication unit 151 can also be referred to as a transmission unit.

The storage unit 152 includes an arbitrary storage medium such as a hard disk or a semiconductor memory, for example, and stores various types of information. For example, the storage unit 152 stores a content file (VVC track), a metadata file, an MPD file, or the like supplied from the communication unit 151 in the storage medium. Furthermore, the storage unit 152 reads requested information from the storage medium and supplies the requested information to a request source. For example, the storage unit 152 reads a requested MPD file from the storage medium, and supplies the MPD file to the communication unit 151 which is a request source. Furthermore, the storage unit 152 reads a content file to be requested or metadata file from the storage medium, and supplies the read content file or metadata file to the generation unit 153 which is a request source.

The generation unit 153 generates a bitstream of the partial region 121 including the segmented region 12 requested to the client apparatus 113 which is another apparatus. That is, the generation unit 153 generates the bitstream of the partial region constituted by some subpictures 11 among the subpictures 11 included in the picture 10 on the basis of a request from the another apparatus. The generation unit 153 generates the bitstream of the partial region 121 by reading necessary information such as a content file and a metadata file from the storage unit 152. The generation unit 153 newly generates a content file (VVC track) to store the bitstream of the partial region 121. The generation unit 153 supplies the content file to the communication unit 151.

### Client Apparatus

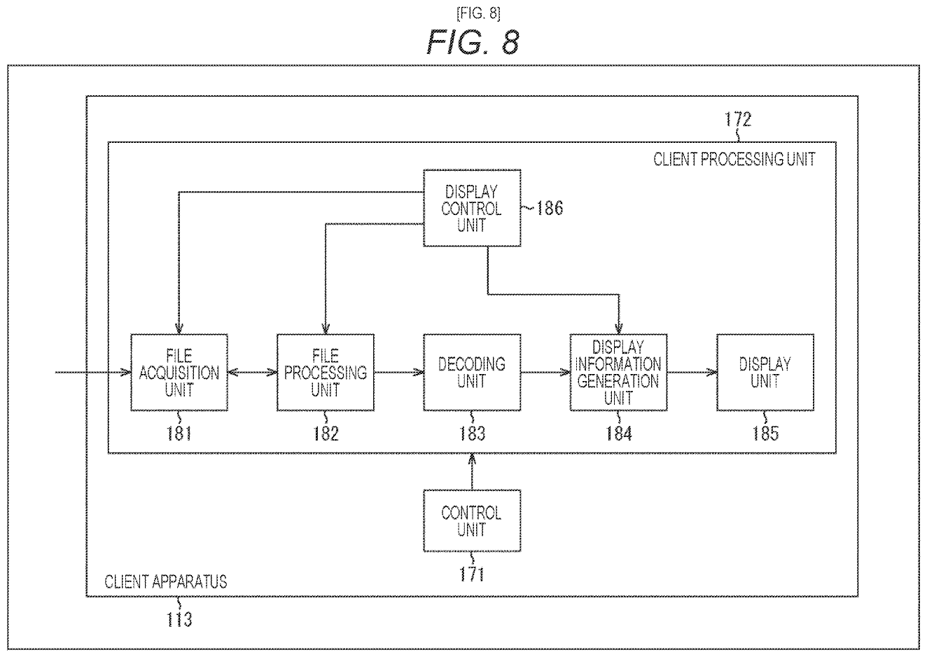

FIG. 8 is a block diagram illustrating an example of a configuration of the client apparatus 113 that is an aspect of the image processing apparatus to which the present technology is applied.

Note that, in FIG. 8, main processing units, main data flows, and the like are illustrated, and those illustrated in FIG. 8 are not necessarily all. That is, in the client apparatus 113, there may be a processing unit not illustrated as a block in FIG. 8, or there may be processing or a data flow not illustrated as an arrow or the like in FIG. 8.

As illustrated in FIG. 8, the client apparatus 113 includes a control unit 171 and a reproduction processing unit 172. The control unit 171 performs processing related to control for the reproduction processing unit 172. The reproduction processing unit 172 performs processing related to reproduction of data of content.

The reproduction processing unit 172 includes a file acquisition unit 181, a file processing unit 182, a decoding unit 183, a display information generation unit 184, a display unit 185, and a display control unit 186.

The file acquisition unit 181 communicates with another apparatus via the network 110 to acquire information. For example, the file acquisition unit 181 requests an MPD file of desired content from the distribution server 112, and receives the MPD file transmitted in response to the request. The file acquisition unit 181 supplies the received MPD file to the file processing unit 182. That is, the file acquisition unit 181 can also be referred to as an acquisition unit or a control file acquisition unit.

Furthermore, the file acquisition unit 181 requests the distribution server 112 for a content file designated from the file processing unit 182 on the basis of the MPD file. At this time, the file acquisition unit 181 requests a bitstream of a region (that is, the partial region 121 of the picture 10) including at least the segmented region 12 designated by the file processing unit 182 or the display control unit 186. That is, the file acquisition unit 181 can also be referred to as a request processing unit.

The file acquisition unit 181 acquires (receives) a content file (VVC track) that stores the bitstream of the partial region 121 distributed in response to the request. The file acquisition unit 181 supplies the acquired content file to the file processing unit 182. That is, the file acquisition unit 181 can also be referred to as an acquisition unit or a content file acquisition unit.

The file processing unit 182 performs processing related to the file supplied from the file acquisition unit 181. For example, the file processing unit 182 acquires an MPD file supplied from the file acquisition unit 181. The file processing unit 182 selects a content file to be requested on the basis of the MPD file, and requests the file acquisition unit 181 to distribute the content file. At this time, in a case where a display region is designated by the display control unit 186, the file processing unit 182 sets the display region as the segmented region 12, and requests the file acquisition unit 181 to distribute a bitstream of a region including at least the segmented region 12.

Furthermore, the file processing unit 182 acquires a content file supplied from the file acquisition unit 181. This content file includes a bitstream of the partial region 121. The file processing unit 182 extracts the bitstream of the partial region 121 from the content file and supplies the bitstream to the decoding unit 183.

The decoding unit 183 decodes the bitstream of the partial region 121 supplied from the file processing unit 182 by VVC to generate image data of the partial region 121. The decoding unit 183 supplies the image data of the partial region 121 to the display information generation unit 184.

The display information generation unit 184 acquires the image data of the partial region 121 supplied from the decoding unit 183. The display information generation unit 184 sets a display region designated by the display control unit 186 as the segmented region 12, segments the segmented region 12 from the partial region 121, and generates display information (a display image or the like). That is, the display information generation unit 184 can also be referred to as a segmentation unit. The display information generation unit 184 supplies the display information to the display unit 185.

The display unit 185 includes a display device, and displays the display information supplied from the display information generation unit 184 using the display device.

The display control unit 186 performs processing related to control of generation of display information. For example, the display control unit 186 receives designation of a display region from a user or an application via the control unit 171, and supplies the designation of the display region to the file processing unit 182 and the display information generation unit 184. Furthermore, the display control unit 186 can also set the display region as the segmented region 12 and request the file acquisition unit 181 to distribute a bitstream of a region including at least the segmented region 12.

### Flow of File Generation Processing

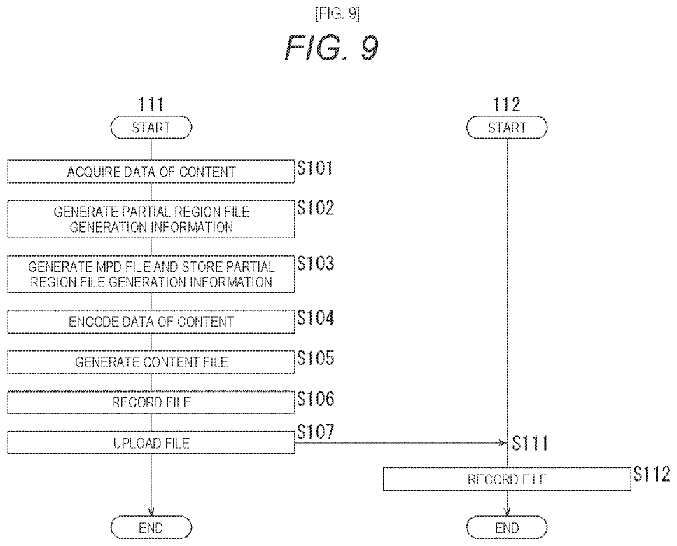

An example of such a flow of processing until the file generation apparatus 111 of the content distribution system 100 generates a file and uploads the file to the distribution server 112 will be described with reference to a flowchart of FIG. 9.

When the processing is started, the input unit 141 of the file generation apparatus 111 acquires data of content including a moving image in step S101. In step S102, the preprocessing unit 142 generates partial region file generation information for generating a file that stores a bitstream of the partial region 121 of the picture 10 on the basis of the data of the moving image. Furthermore, the preprocessing unit 142 generates metadata for generating the bitstream of the partial region constituted by a subpicture on the basis of the data of the moving image. In step S103, the file generation unit 144 generates an MPD file which is a control file for controlling distribution of a content file, and stores the partial region file generation information generated in step S102 in the MPD file. Furthermore, the file generation unit 144 generates a metadata file and stores the metadata generated in step S102 in the metadata file.

In step S104, the encoding unit 143 encodes the data of the content acquired in step S101 to generate a bitstream. For example, the encoding unit 143 encodes the data of the moving image by VVC to generate a bitstream of the picture 10. In step S105, the file generation unit 144 generates a content file and stores a bitstream of the content generated in step S104. For example, the file generation unit 144 stores the bitstream of the picture 10 in the content file (VVC track).

In step S106, the recording unit 145 records the MPD file and the metadata generated in step S103 and the content file generated in step S105. In step S107, the output unit 146 reads the files from the recording unit 145 and uploads the files to the distribution server 112 via the network 110.

In step S111, the communication unit 151 of the distribution server 112 receives the files transmitted from the file generation apparatus 111. In step S112, the storage unit 152 stores the received files (that is, the MPD file, the content file, the metadata file, and the like).

### Flow of Content Distribution Processing

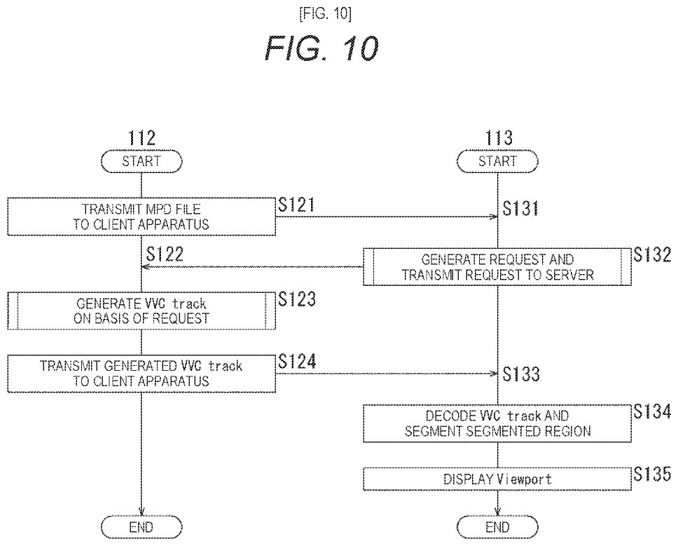

An example of such a flow of processing in which the distribution server 112 of the content distribution system 100 distributes content to the client apparatus 113 will be described with reference to a flowchart of FIG. 10.

The processing is started when the client apparatus 113 requests the distribution server 112 to transmit an MPD file of desired content. In step S121, the communication unit 151 of the distribution server 112 reads the requested MPD file from the storage unit 152, and transmits the MPD file to the client apparatus 113. In step S131, the file acquisition unit 181 of the client apparatus 113 receives the MPD file.

In step S132, the file processing unit 182 analyzes the MPD file. The file acquisition unit 181 generates a request for a content file on the basis of the analysis result. The file acquisition unit 181 transmits the request to the distribution server 112. That is, the file acquisition unit 181 requests a bitstream of a partial region of a picture on the basis of partial region file generation information for generating a file that stores the bitstream of the partial region of the picture included in a control file that controls distribution of the content file. In step S122, the communication unit 151 of the distribution server 112 receives the request.

In step S123, the generation unit 153 reads necessary information from the storage unit 152 on the basis of the request, generates a bitstream of the partial region 121 constituted by some subpictures 11 among the subpictures 11 included in the picture 10, generates a new content file (VVC track), and stores the bitstream of the partial region 121.

In step S124, the communication unit 151 transmits the content file (VVC track) generated in step S123 to the client apparatus 113. In step S133, the file acquisition unit 181 of the client apparatus 113 receives the content file.

In step S134, the file processing unit 182 extracts the bitstream of the partial region 121 from the content file. The decoding unit 183 decodes the bitstream of the partial region 121 to generate image data of the partial region 121. The display information generation unit 184 segments the segmented region 12 from the partial region 121. In step S135, the display unit 185 displays the segmented region 12 as a display region.

### Flow of Request Processing

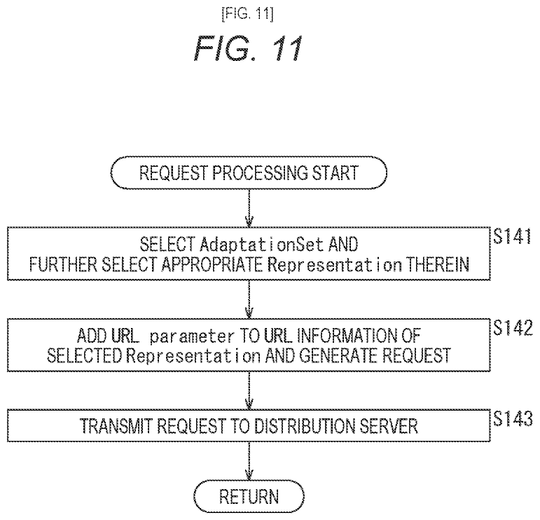

Next, an example of a flow of request processing executed in step S132 of FIG. 10 will be described with reference to a flowchart of FIG. 11.

When the processing is started, in step S141, the file processing unit 182 of the client apparatus 113 selects an adaptation set (AdaptationSet) corresponding to a desired content file from a description of an MPD file, and further selects an appropriate representation therein.

In step S142, the file acquisition unit 181 appropriately adds a URL parameter to URL information of the representation selected in step S141 to generate a request.

In step S143, the file acquisition unit 181 transmits the request generated in step S142 to the distribution server 112. When the process of step S143 ends, the request processing ends, and the processing returns to FIG. 10.

As the respective processes are executed as described above, the content distribution system 100 can suppress an increase in a transmission data amount from the distribution server 112 to the client apparatus 113. Furthermore, it is possible to suppress an increase in a processing load of the distribution server 112. That is, the content distribution system 100 can suppress an increase in a processing load of the client apparatus 113 while suppressing an increase in the processing load of the distribution server 112.

### 3. Extraction of Partial Region

### Method 1

In the content distribution as described above, a method for generating the partial region 121 by the distribution server 112 is arbitrary. For example, as illustrated in the second row from the top of the table illustrated in FIG. 4, the distribution server 112 may generate a bitstream of the partial region 121 by performing processing of extracting the partial region 121 from the picture 10 (Method 1). Since the partial region 121 is the region constituted by the subpictures 11 as described above, the distribution server 112 can extract the bitstream of the partial region 121 without decoding a bitstream of the picture 10.

In this case, as illustrated in FIG. 7, the storage unit 152 of the distribution server 112 stores an MPD file 161 and a VVC track 162 which is a content file that stores the bitstream of the picture 10. Moreover, the storage unit 152 stores a VVC extraction base track 163-1, a VVC extraction base tracks 163-2, and so on which are metadata files that store metadata for extracting the subpicture 11 constituting the partial region 121 from the picture 10. In a case where it is not necessary to describe the respective metadata files in a distinguishable manner, they are also referred to as VVC extraction base tracks 163. The storage unit 152 can store an arbitrary number of the VVC extraction base tracks 163.

The VVC extraction base track 163 is metadata used for extraction processing of the subpicture 11, and is prepared for each number of subpictures 11 to be extracted. For example, the VVC extraction base track 163-1 is metadata that is applied to processing of extracting any one subpicture. Furthermore, the VVC extraction base track 163-2 is metadata that is applied to processing of extracting any two subpictures. Similarly, the VVC extraction base track 163 that is applied to processing of extracting any three subpictures may be prepared, or the VVC extraction base track 163 that is applied to processing of extracting a larger number of subpictures may be prepared.

Note that each of the VVC extraction base tracks 163 is generated by the file generation apparatus 111 and uploaded to the distribution server 112 together with the MPD file 161 and the VVC track 162. The storage unit 152 stores these uploaded files.

The generation unit 153 identifies the subpicture 11 corresponding to a request from the client apparatus 113. The generation unit 153 selects the VVC extraction base track 163 from which the identified subpicture 11 can be extracted. The generation unit 153 reads the selected VVC extraction base track 163 from the storage unit 152 together with the VVC track 162. Then, the generation unit 153 extracts a bitstream of the partial region 121 constituted by the selected subpicture 11 (that is, subpicture 11 corresponding to the request from client apparatus 113) from the bitstream of the picture 10 stored in the VVC track 162 using the read VVC extraction base track 163. Then, the generation unit 153 generates a new VVC track and stores the bitstream of the partial region 121. Then, the generation unit 153 supplies the VVC track to the communication unit 151 to be transmitted to the client apparatus 113.

In this manner, the distribution server 112 can generate the bitstream of the partial region 121 without decoding (that is, easily) the bitstream of the picture 10. Therefore, an increase in a load on the distribution server 112 can be suppressed.

Note that processing of extracting a bitstream of the partial region 121 from a bitstream of the picture 10 may be performed in the client apparatus 113. In this case, the distribution server 112 transmits a content file including the bitstream of the picture 10 to the client apparatus 113. Therefore, as described above, the distribution server 112 extracts the bitstream of the partial region 121 from the bitstream of the picture 10, so that an increase in a data transmission amount can be suppressed. That is, it is possible to suppress an increase in a processing load of the client apparatus 113.

### Method 1-1

In a case where Method 1 is applied, as illustrated in the third row from the top of the table illustrated in FIG. 4, partial region file generation information may be stored in an adaptation set of a content file (VVC track) that stores a bitstream of the entire picture 10 of the MPD file (Method 1-1). For example, the partial region file generation information may include information indicating that the distribution server 112 can apply the above-described Method 1 and generate a bitstream of a partial region. In other words, the preprocessing unit 142 of the file generation apparatus 111 may generate the partial region file generation information including the information indicating that the bitstream of the partial region 121 can be generated in the distribution server 112.

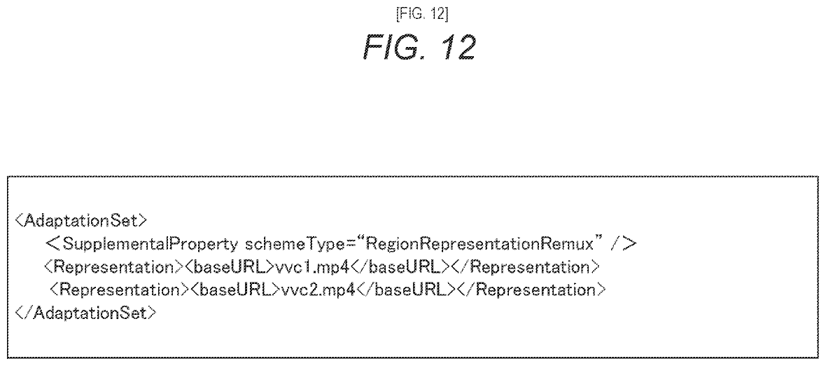

For example, a description as illustrated in FIG. 12 may be stored in the adaptation set corresponding to the content file (VVC track) that stores the bitstream of the entire picture 10 of the MPD file. That is, metadata (schemeType=“RegionRepresentationRemux”) indicating that the bitstream of the partial region 121 can be generated in the distribution server 112 may be described in a supplemental property (SupplementalProperty). With such a description, the file processing unit 182 of the client apparatus 113 that analyzes the MPD file can grasp that the bitstream of the partial region 121 can be generated in the distribution server 112 on the basis of this description. Then, on the premise of such grasping, the file acquisition unit 181 can request the distribution server 112 for a bitstream of a region including at least the segmented region 12. That is, the file acquisition unit 181 can make a request that can be handled by the distribution server 112. Therefore, the distribution server 112 can more reliably perform processing in response to a request from the client apparatus 113.

Moreover, a type of metadata that can be processed by the distribution server 112 may be designated in partial region file generation information. In other words, the preprocessing unit 142 of the file generation apparatus 111 may generate the partial region file generation information including information designating a type of information that can be processed by the distribution server 112.

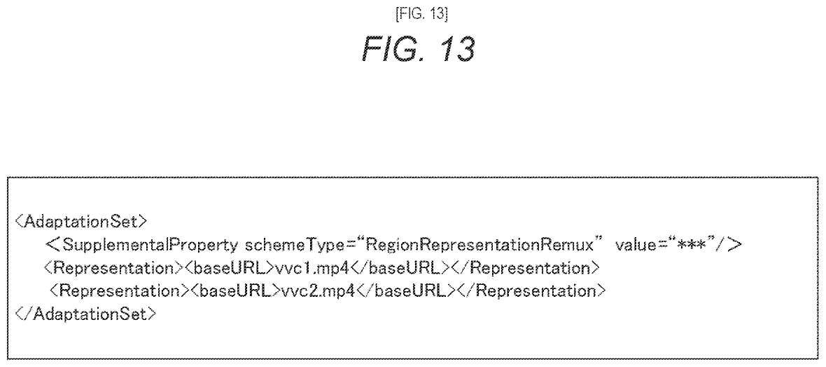

For example, a description as illustrated in FIG. 13 may be stored in the adaptation set corresponding to the content file (VVC track) that stores the bitstream of the entire picture 10 of the MPD file. That is, in the supplemental property (SupplementalProperty), a type of metadata (value=“ ***”) that can be processed by the distribution server 112 in the distribution server 112 may be designated.

In “ ***”, metadata indicating a request method that can be used in the above content file request (request from the client apparatus 113 to the distribution server 112) is described. For example, metadata such as region, priority_size_req, viewport360, group_id, subpic_id, source_id, and track_id may be described. “region” indicates that a method of designating the segmented region 12 by a coordinate or the like can be used. “priority_size_req” indicates that a method of selecting whether to prioritize distribution of a bitstream of the segmented region 12 or distribution of a bitstream of the partial region 121 can be used. “viewport360” indicates that a method of designating the segmented region 12 by a display region (Viewport) of a 360-degree video can be used in the content file request. “group_id” indicates that a method of designating a region of a trif sample group by identification information can be used. “subpic_id” indicates that a method of designating the subpicture 11 by identification information can be used. “source_id” indicates that a method of designating a region defined in an MPD file can be used. “track_id” indicates that a method of designating a track that can be merged by identification information can be used.

### Method 1-1-1

In a case where the above-described Method 1-1 is applied, as illustrated in the fourth row from the top of the table illustrated in FIG. 4, the segmented region 12 that is desired to be acquired may be designated by a coordinate or the like in the above-described content file request (request from the client apparatus 113 to the distribution server 112) (Method 1-1-1). That is, the file acquisition unit 181 of the client apparatus 113 may generate the request for the content file including a parameter that designates the segmented region 12 that is desired to be acquired by the coordinate or the like. In other words, the generation unit 153 of the distribution server 112 may identify the subpicture 11 including the segmented region 12 designated using the coordinate in the content file request, select metadata from which the identified subpicture 11 can be extracted, and extract a bitstream of the partial region 121 constituted by the identified subpicture 11 from a bitstream of the picture 10 using the selected metadata.

For example, in the content file request, the file acquisition unit 181 of the client apparatus 113 adds a URL parameter to the URL designating the content file to be requested as in the following description, for example.

http://hoge.com/vvc.mp4?region_top=100 & region_left=200 & region_width=1024 & region_height=512

In this description, “http://hoge.com/vvc.mp4” indicates an example of a URL that designates the content file to be requested. “region_top” is a URL parameter indicating a top coordinate (that is, a Y coordinate of an upper left end of the segmented region 12) of the segmented region 12. “region_left” is a URL parameter indicating a left coordinate (that is, an X coordinate of the upper left end of the segmented region 12) of the segmented region 12. “region_width” is a URL parameter indicating a width (length in the X direction) of the segmented region 12. “region_height” is a URL parameter indicating a height (length in the Y direction) of the segmented region 12.

The generation unit 153 of the distribution server 112 specifies a region designated by these parameters as the segmented region 12 requested by the client apparatus 113.

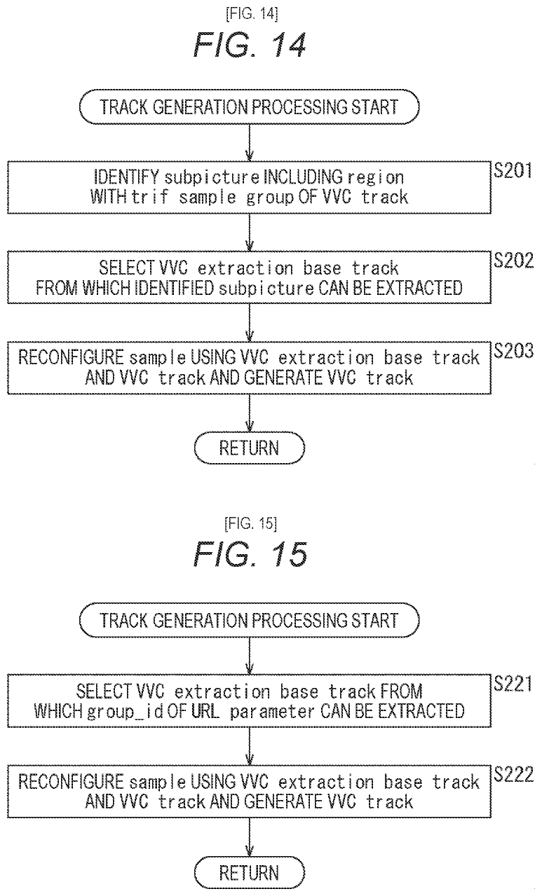

An example of a flow of track generation processing executed by the generation unit 153 of the distribution server 112 in step S123 of FIG. 10 in this case will be described with reference to a flowchart of FIG. 14.

In step S201, the generation unit 153 of the distribution server 112 identifies the subpicture 11 including the segmented region 12 designated in a request in a trif sample group of the VVC track 162 that stores a bitstream of the picture 10 read from the storage unit 152. In step S202, the generation unit 153 selects metadata (VVC extraction base track 163) from which the subpicture identified in step S201 can be extracted from the VVC track 162, and reads the metadata from the storage unit 152. In step S203, the generation unit 153 reconfigures a sample using the read VVC extraction base track 163 and VVC track 162, and generates a bitstream of the partial region 121 including the segmented region 12. That is, the generation unit 153 extracts the bitstream of the partial region 121 from the bitstream of the picture 10 on the basis of the VVC extraction base track 163. Then, the generation unit 153 newly generates a content file (VVC track) and stores the bitstream of the partial region 121 therein. When the process of step S203 ends, the track generation processing ends, and the processing returns to FIG. 10.

In this manner, the client apparatus 113 can more directly designate the segmented region 12 that is desired to be acquired, and thus, is not required to perform processing such as interpreting other information, and can make a request for a content file more easily. Furthermore, the distribution server 112 that receives the request can more reliably specify the requested segmented region 12 since the segmented region 12 is more directly designated.

Note that, in this case, the distribution server 112 may be able to distribute not only the bitstream of the partial region 121 but also a bitstream of the segmented region 12. That is, the distribution server 112 may decode the bitstream of the picture 10, extract the segmented region 12, generate the bitstream of the segmented region 12 by encoding, and distribute the bitstream of the segmented region 12.

In that case, in the content file request, it may be designated that the distribution of the bitstream of the segmented region 12 is prioritized over the distribution of the bitstream of the partial region 121. For example, in a case where a request for generation with priority on a data size (only the requested segmented region 12) is made, the file acquisition unit 181 of the client apparatus 113 may add “priority_size_req” to the URL parameter. Then, in a case where the “priority_size_req” is added to the request, the generation unit 153 of the distribution server 112 may generate the bitstream of the segmented region 12 instead of generating the bitstream of the partial region 121 in accordance with a situation. For example, the generation unit 153 may generate the bitstream of the requested segmented region 12 in a case where there is a margin in a processing load of the distribution server 112, and may generate the bitstream of the partial region 121 including the requested segmented region 12 in a case where there is no margin in the load.

Note that, in a case where “priority_size_req” is not added to this URL parameter, the generation unit 153 does not generate the segmented region 12 but generates only the bitstream of the partial region 121.

For example, the file acquisition unit 181 of the client apparatus 113 may generate a request for a content file including a parameter designating that distribution of a bitstream of the segmented region 12 that is desired to be acquired is prioritized.

Then, for example, the generation unit 153 may generate a bitstream of a partial region in a case where a bitstream of a subpicture is requested, and may generate a bitstream of a segmented region by decoding a bitstream of a picture, segmenting the segmented region from the picture, and encoding the segmented region in a case where the bitstream of the segmented region is requested.

In this manner, it is possible to further suppress the increase in the data transmission amount from the distribution server 112 to the client apparatus 113.

Furthermore, in a case where content to be distributed is a 360-degree video, the segmented region 12 that is desired to be acquired may be designated using a parameter related to a display region (Viewport) in the content file request. The parameter related to the display region is arbitrary. For example, parameters such as centre_azimuth, centre_elevation, centre_tilt, azimuth_range and elevation_range may be applied. “centre_azimuth” is a parameter indicating an azimuth angle of the center of the display region. “centre_elevation” is a parameter indicating an elevation angle of the center of the display region. “centre_tilt” is a parameter indicating rotation of the center of the display region. “azimuth_range” is a parameter indicating a view angle of the display region in the horizontal direction. “elevation_range” is a parameter indicating a length of the display region in the height direction.

For example, the file acquisition unit 181 of the client apparatus 113 may generate a request for a content file including a parameter related to a display region (Viewport), the request designating the segmented region 12 that is desired to be acquired. In other words, the generation unit 153 of the distribution server 112 may identify the subpicture 11 including the segmented region 12 designated using information regarding the display region in the content file request, select metadata from which the identified subpicture 11 can be extracted, extract the identified subpicture 11 from a bitstream of the picture 10 using the selected metadata, and generate a bitstream of the partial region 121 constituted by the extracted subpicture 11.

### Method 1-1-2

In a case where the above-described Method 1-1 is applied, as illustrated in the fifth row from the top of the table illustrated in FIG. 4, in the above-described content file request (request from the client apparatus 113 to the distribution server 112), a group id of a region including a necessary portion may be specified from a trif sample group in a VVC track (Method 1-1-2). “trif” has position information and size information of a picture as region information, and can identify each information by group_id. Therefore, group_id indicating region including a necessary portion is added as a URL parameter. For example, a case where group_id=1 and 2 are acquired is described as follows.

http://hoge.com/vvc.mp4?group_id=1& group_id=2

In this description, “http://hoge.com/vvc.mp4” indicates an example of a URL that designates the content file to be requested. “group_id=1 & group_id=2” is a URL parameter that designates a region corresponding to group id=1 and a region corresponding to group id=2.

For example, the file acquisition unit 181 of the client apparatus 113 may generate a content file request including identification information (group_id) for identifying a region of the trif sample group. In other words, the generation unit 153 of the distribution server 112 may select metadata (VVC extraction base track 163) from which the partial region 121 including the region designated using the identification information (group_id) in the request can be extracted, and extract a bitstream of the partial region 121 from a bitstream of the picture 10 using the selected metadata.

An example of a flow of track generation processing executed by the generation unit 153 of the distribution server 112 in step S123 of FIG. 10 in that case will be described with reference to a flowchart of FIG. 15.

In step S221, the generation unit 153 of the distribution server 112 selects metadata (VVC extraction base track 163) from which the partial region 121 including a region indicated by group_id of a URL parameter included in a content file request can be extracted, and reads the metadata from the storage unit 152. In step S222, the generation unit 153 reconfigures a sample using the read VVC extraction base track 163 and VVC track 162, and generates a bitstream of the partial region 121 including the segmented region 12. That is, the generation unit 153 extracts the bitstream of the partial region 121 from the bitstream of the picture 10 on the basis of the VVC extraction base track 163. Then, the generation unit 153 newly generates a content file (VVC track) and stores the bitstream of the partial region 121 therein. When the process of step S222 ends, the track generation processing ends, and the processing returns to FIG. 10.

In this manner, the distribution server 112 can omit identification of the subpicture 11 including the segmented region 12, and can further suppress the increase in the processing load.

Note that, instead of the above-described group id, a region including a necessary portion may be designated using subpic_id of a spid sample group. “subpic_id” is identification information for identifying the subpicture 11.

For example, the file acquisition unit 181 of the client apparatus 113 may generate a content file request including identification information (subpic_id) indicating the subpicture 11. In other words, the generation unit 153 of the distribution server 112 may select metadata (VVC extraction base track 163) from which the subpicture 11 designated using the identification information (subpic_id) in the request can be extracted, extract the subpicture 11 from a bitstream of the picture 10 using the selected metadata, and generate a bitstream of the partial region 121 constituted by the extracted subpicture 11.

### Method 1-1-3

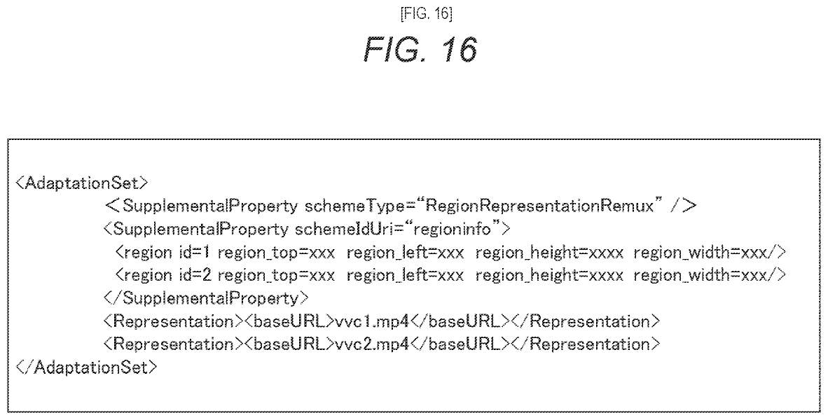

In a case where the above-described Method 1-1 is applied, as illustrated in the sixth row from the top of the table illustrated in FIG. 4, regionInfo of a supplemental property indicating region information may be added to an adaptation set of a content file (VVC track) in an MPD file (Method 1-1-3). For example, a description as illustrated in FIG. 16 is stored in the MPD file. That is, a region and its identification information (region id) are defined in the MPD file, and the region including the segmented region 12 is designated using the identification information in a request for the content file. For example, a case where id (region id)=1 and 2 is described as follows.

http://hoge.com/vvc.mp4?id=1&id=2

In this description, “http://hoge.com/vvc.mp4” indicates an example of a URL that designates the content file to be requested. “id=1 & id=2” is a URL parameter that designates a region corresponding to region id=1 and a region corresponding to region id=2.

For example, the preprocessing unit 142 of the file generation apparatus 111 may generate the description as illustrated in FIG. 16 as partial region file generation information, and the file generation unit 144 may store the description in a control file (MPD file) that controls distribution of the content file. Furthermore, the file acquisition unit 181 of the client apparatus 113 may generate a content file request including identification information (region id) defined in a control file (MPD file) that controls distribution of the content file. That is, the file acquisition unit 181 may designate the region id of the region including the segmented region 12 in the content file request. Moreover, the generation unit 153 of the distribution server 112 may select metadata (VVC extraction base track 163) from which the subpicture 11 constituting the partial region 121 including the region designated using the identification information (region id) defined in the control file (MPD file) that controls the distribution of the content file can be extracted, and extract a bitstream of the partial region 121 from a bitstream of the picture 10 using the selected metadata.

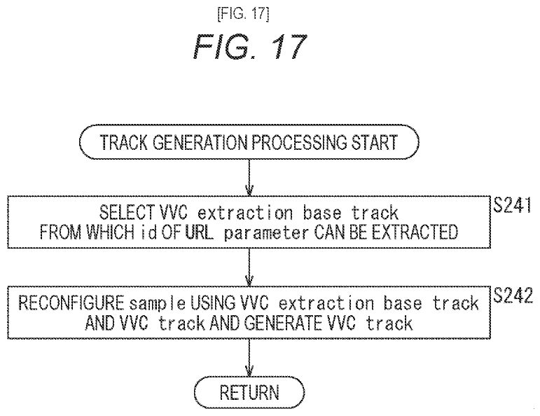

An example of a flow of track generation processing executed by the generation unit 153 of the distribution server 112 in step S123 of FIG. 10 in that case will be described with reference to a flowchart of FIG. 17.

In step S241, the generation unit 153 of the distribution server 112 selects metadata (VVC extraction base track 163) from which the partial region 121 including a region indicated by id of a URL parameter included in a content file request can be extracted, and reads the metadata from the storage unit 152. In step S242, the generation unit 153 reconfigures a sample using the read VVC extraction base track 163 and VVC track 162, and generates a bitstream of the partial region 121 including the region. That is, the generation unit 153 extracts the bitstream of the partial region 121 from the bitstream of the picture 10 on the basis of the VVC extraction base track 163. Then, the generation unit 153 newly generates a content file (VVC track) and stores the bitstream of the partial region 121 therein. When the process of step S242 ends, the track generation processing ends, and the processing returns to FIG. 10.

In this manner, the client apparatus 113 can more reliably designate the partial region 121 that can be extracted by the distribution server 112.

Note that, instead of the identification information defined in the MPD, region information (a position, a size, and the like of region) defined in the MPD may be described in the content file request. In this case, in the MPD file, an adaptation set is described for each combination of partial regions that can be acquired. For example, an adaptation set is defined for each combination of partial regions, such as an adaptation set of partial regions A+B or an adaptation set of partial regions A+C. Therefore, a partial region to be requested is designated by a URL in the content file request. That is, no URL parameter is added. The generation unit 153 of the distribution server 112 generates a VVC track including the entire region of regionInfo corresponding to the designated URL.

For example, the generation unit 153 of the distribution server 112 may select metadata (VVC extraction base track 163) from which the subpicture 11 constituting the partial region 121 including a region designated in a request for a content file can be extracted among out of a region defined as an adaptation set in a control file (MPD file) that controls distribution of the content file, and extract a bitstream of the partial region 121 from a bitstream of the picture 10 using the selected metadata.

### Method 1-2

In a case where Method 1 is applied, as illustrated in the bottom row of the table illustrated in FIG. 4, partial region file generation information may be stored in the VVC extraction base track (Method 1-2). For example, the partial region file generation information may include information indicating that the distribution server 112 can apply the above-described Method 1 and generate a bitstream of a partial region. In other words, the preprocessing unit 142 of the file generation apparatus 111 may generate the partial region file generation information including the information indicating that the bitstream of the partial region 121 can be generated in the distribution server 112.

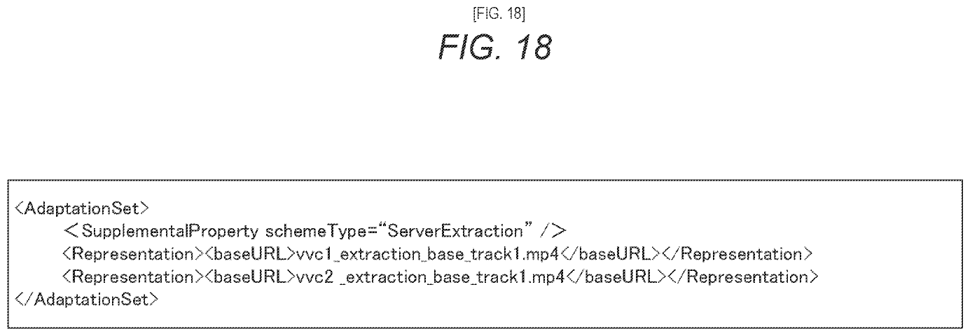

For example, a description as illustrated in FIG. 18 may be stored in an adaptation set corresponding to metadata (VVC extraction base track 163) for extracting the subpicture 11 in an MPD file. That is, metadata (schemeType=“ServerExtraction”) indicating that a bitstream of the partial region 121 can be generated in the distribution server 112 may be described in a supplemental property (SupplementalProperty). With such a description, the file processing unit 182 of the client apparatus 113 that analyzes the MPD file can grasp that the distribution server 112 can generate the bitstream of the partial region 121 by using the metadata (VVC extraction base track 163) on the basis of the description. Then, on the premise of such grasping, the file acquisition unit 181 can request the distribution server 112 for a bitstream of a region including at least the segmented region 12. That is, the file acquisition unit 181 can make a request that can be handled by the distribution server 112. Therefore, the distribution server 112 can more reliably perform processing in response to a request from the client apparatus 113.

That is, in this case, the file acquisition unit 181 of the client apparatus 113 designates the partial region 121 to be requested by designating the metadata (VVC extraction base track 163) to be used by the distribution server 112 in the content file request. For example, in the content file request, the file acquisition unit 181 of the client apparatus 113 designates the metadata (VVC extraction base track 163) to be used by the distribution server 112 using a URL as described below, and adds the following URL parameter to the URL.

http://hoge.com/vvc_extraction_base_track.mp4?Serve rExtraction

In this description, “http://hoge.com/vvc_extraction_base_track.mp4” indicates an example of the URL that designates the metadata (VVC extraction base track 163) for extracting the subpicture. “ServerExtraction” is a URL parameter for requesting extraction of the partial region 121.

Then, in a case where the URL parameter is added, the generation unit 153 of the distribution server 112 extracts the partial region 121 using the metadata (VVC extraction base track 163) designated by the URL. For example, the generation unit 153 of the distribution server 112 may extract a bitstream of the partial region 121 from a bitstream of the picture 10 using the metadata (VVC extraction base track 163) for extracting the subpicture 11 designated in the content file request.

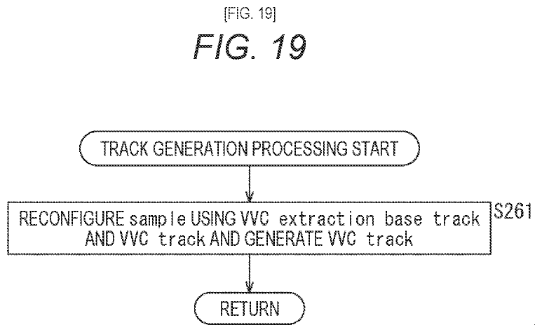

An example of a flow of track generation processing executed by the generation unit 153 of the distribution server 112 in step S123 of FIG. 10 in this case will be described with reference to a flowchart of FIG. 19.

In step S261, the generation unit 153 of the distribution server 112 reads the VVC extraction base track 163 and the VVC track 162 designated in a request for a content file from the storage unit 152, reconfigures a sample using the read information, and generates a bitstream of the partial region 121 including the segmented region 12. That is, the generation unit 153 extracts the bitstream of the partial region 121 from a bitstream of the picture 10 using the VVC extraction base track 163 designated in the content file request. Then, the generation unit 153 newly generates a content file (VVC track) and stores the bitstream of the partial region 121 therein. When the process of step S261 ends, the track generation processing ends, and the processing returns to FIG. 10.

In this manner, the VVC track of a region that can be generated by the distribution server 112 can be clearly indicated to the client apparatus 113.

Note that group_id may be designated in a content file request. The VVC extraction base track 163 may be capable of selecting a partial region that can be extracted. In that case, a partial region to be extracted from among extractable candidates may be designated using group_id. In that case, the content file request is similar to that in the case of Method 1-1-2. The addition of the URL parameter (ServerExtraction) described above in Method 1-2 can be omitted.

Furthermore, an adaptation set dedicated to ServerExtraction may be described in an MPD file. In that case, as described below, the designation is performed not by the sample property (Supplemental property) but by an essential property (EssentialProperty). A URL for ServerExtraction is designated.

<EssentialProperty schemeType=“ServerExtraction”/>

In this case, the addition of the URL parameter (ServerExtraction) described above in Method 1-2 can be omitted. Furthermore, group_id may be designated in a content file request. In a case where a file indicated by this adaptation set is accessed, the file is treated as if it is in the distribution server 112.

### 4. Merge of Subpictures

### Method 2

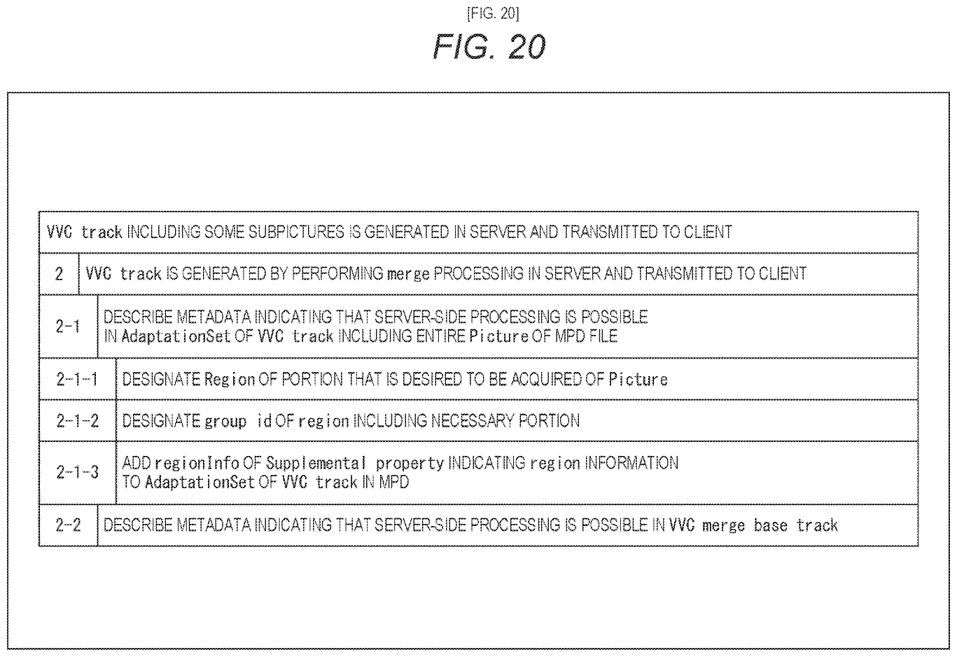

Furthermore, for example, as illustrated in the second row from the top of the table illustrated in FIG. 20, the distribution server 112 may generate a bitstream of the partial region 121 by performing merge processing of merging the subpictures 11 (Method 2). Since the partial region 121 is the region constituted by the subpictures 11 as described above, the distribution server 112 can generate the bitstream of the partial region 121 without decoding a bitstream of the subpicture 11.

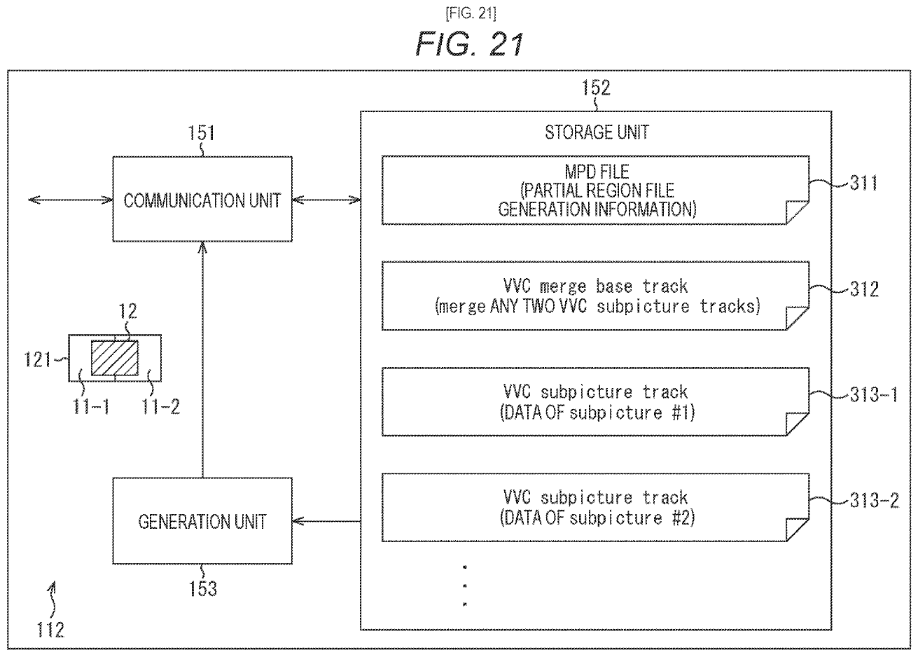

In this case, the storage unit 152 of the distribution server 112 stores an MPD file 311 as illustrated in FIG. 21. Furthermore, the storage unit 152 stores a VVC merge base track 312 which is a metadata file that stores metadata for merging the subpicture 11. Moreover, the storage unit 152 stores a VVC subpicture track 313-1 which is a content file that stores a bitstream of subpicture #1, a VVC subpicture tracks 313-2 which is a content files that stores a bitstream of subpicture #2, and so on. In a case where it is not necessary to describe the content files storing the bitstreams of the subpictures 11 to be distinguished from each other, they are referred to as VVC subpicture tracks 313. That is, the storage unit 152 stores the VVC subpicture track 313 for each subpicture constituting the picture 10.

Note that the VVC merge base track 312 is a metadata file for merging any two VVC subpicture tracks 313. The number of VVC subpicture tracks 313 to be merged is arbitrary. The VVC merge base track is only required to be prepared for each number of VVC subpicture tracks 313 to be merged. That is, only the VVC merge base track 312 is illustrated in FIG. 21, but the storage unit 152 may store a metadata file for merging three or more VVC subpicture tracks 313 in addition to the VVC merge base track 312.

Note that the VVC merge base track 312 is generated by the file generation apparatus 111 and uploaded to the distribution server 112 together with the MPD file 311 and the VVC subpicture track 313. The storage unit 152 stores these uploaded files.

The generation unit 153 identifies the subpicture 11 corresponding to a request from client apparatus 113 (the subpicture 11 constituting the partial region 121 including the requested segmented region 12). The generation unit 153 selects the VVC merge base track 312 that can merge the identified subpicture 11. The generation unit 153 reads the selected VVC merge base track 312 and the identified VVC subpicture track 313 of the subpicture 11 from the storage unit 152. Then, the generation unit 153 generates a bitstream of the requested partial region 121 by merging the respective read VVC subpicture tracks 313 (bitstreams of the subpictures 11 stored in the respective VVC subpicture tracks 313) using the read VVC merge base track 312. Then, the generation unit 153 generates a new VVC track and stores the bitstream of the partial region 121. Then, the generation unit 153 supplies the VVC track to the communication unit 151 to be transmitted to the client apparatus 113.

In this manner, the distribution server 112 can generate the bitstream of the partial region 121 without decoding (that is, easily) the bitstream of the picture 10. Therefore, an increase in a load on the distribution server 112 can be suppressed.

Note that the processing of merging the subpictures 11 to generate the bitstream of the partial region 121 may be performed in the client apparatus 113, but the increase in the processing load of the client apparatus 113 can be further suppressed by performing this merge processing in the distribution server 112.

### Method 2-1

In a case where Method 2 is applied, as illustrated in the third row from the top of the table illustrated in FIG. 20, partial region file generation information may be stored in an adaptation set of a content file (VVC track) that stores a bitstream of the entire picture 10 of the MPD file (Method 2-1). For example, the partial region file generation information may include information indicating that the distribution server 112 can apply the above-described Method 2 and generate a bitstream of a partial region. In other words, the preprocessing unit 142 of the file generation apparatus 111 may generate the partial region file generation information including the information indicating that the bitstream of the partial region 121 can be generated in the distribution server 112.

For example, as illustrated in FIG. 12, metadata (schemeType=“RegionRepresentationRemux”) indicating that the bitstream of the partial region 121 can be generated in the distribution server 112 may be described in a supplemental property (SupplementalProperty) of the adaptation set corresponding to the content file (VVC track) that stores the bitstream of the entire picture 10 of the MPD file. With such a description, the file processing unit 182 of the client apparatus 113 that analyzes the MPD file can grasp that the bitstream of the partial region 121 can be generated in the distribution server 112 on the basis of this description. Then, on the premise of such grasping, the file acquisition unit 181 can request the distribution server 112 for a bitstream of a region including at least the segmented region 12. That is, the file acquisition unit 181 can make a request that can be handled by the distribution server 112. Therefore, the distribution server 112 can more reliably perform processing in response to a request from the client apparatus 113.

Moreover, a type of metadata that can be processed by the distribution server 112 may be designated in partial region file generation information. In other words, the preprocessing unit 142 of the file generation apparatus 111 may generate the partial region file generation information including information designating a type of information that can be processed by the distribution server 112.

For example, as illustrated in FIG. 13, a type of metadata (value=“ ***”) that can be processed by the distribution server 112 in the distribution server 112 may be designated in the supplemental property (SupplementalProperty) of the adaptation set corresponding to the content file (VVC track) that stores the bitstream of the entire picture 10 of the MPD file. In “ ***”, metadata similar to that described in <Method 1-1> is described.

### Method 2-1-1

In a case where the above-described Method 2-1 is applied, as illustrated in the fourth row from the top of the table illustrated in FIG. 20, the segmented region 12 that is desired to be acquired may be designated by a coordinate or the like in the above-described content file request (request from the client apparatus 113 to the distribution server 112) (Method 2-1-1). That is, the file acquisition unit 181 of the client apparatus 113 may generate the request for the content file including a parameter that designates the segmented region 12 that is desired to be acquired by the coordinate or the like. In other words, the generation unit 153 of the distribution server 112 may identify the subpicture 11 including the segmented region 12 designated using the coordinate in the content file request, select metadata (VVC merge base track 312) from which the identified subpicture 11 can be extracted, and generate a bitstream of the partial region 121 by merging a bitstream (VVC subpicture track 313) of the identified subpicture 11 using the selected metadata.

For example, in the content file request, the file acquisition unit 181 of the client apparatus 113 adds the above-described URL parameter to the URL designating the content file to be requested as in <Method 2-1-1>, for example. The generation unit 153 of the distribution server 112 specifies a region designated by these parameters as the segmented region 12 requested by the client apparatus 113.

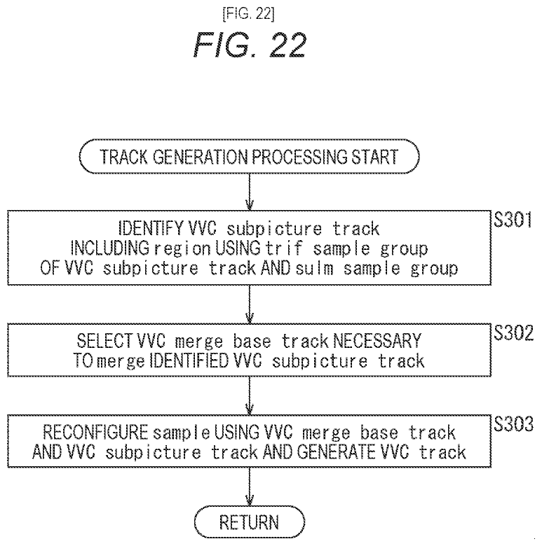

An example of a flow of track generation processing executed by the generation unit 153 of the distribution server 112 in step S123 of FIG. 10 in this case will be described with reference to a flowchart of FIG. 22.

In step S301, the generation unit 153 of the distribution server 112 uses a trif sample group and a sulm sample group of the VVC subpicture track 313 to identify the subpicture 11 (that is, the VVC subpicture track 313 that stores a bitstream of the subpicture 11) including the requested segmented region 12. In step S302, the generation unit 153 selects metadata (VVC merge base track 312) necessary for merging bitstreams (VVC subpicture tracks 313) of the identified subpictures 11, and reads the metadata from the storage unit 152. In step S303, the generation unit 153 reconfigures a sample using the read VVC merge base track 312 and the identified VVC subpicture tracks 313, and generates a bitstream of the partial region 121 including the segmented region 12. That is, the generation unit 153 generates the bitstream of the partial region 121 by merging the identified bitstreams of the subpictures 11 on the basis of the VVC merge base track 312. Then, the generation unit 153 newly generates a content file (VVC track) and stores the bitstream of the partial region 121 therein. When the process of step S303 ends, the track generation processing ends, and the processing returns to FIG. 10.

In this manner, the client apparatus 113 can more directly designate the segmented region 12 that is desired to be acquired, and thus, is not required to perform processing such as interpreting other information, and can make a request for a content file more easily. Furthermore, the distribution server 112 that receives the request can more reliably specify the requested segmented region 12 since the segmented region 12 is more directly designated.

Note that, in this case, the distribution server 112 may be able to distribute not only the bitstream of the partial region 121 but also a bitstream of the segmented region 12. That is, the distribution server 112 may decode the bitstream of the picture 10, extract the segmented region 12, generate the bitstream of the segmented region 12 by encoding, and distribute the bitstream of the segmented region 12.

In that case, in the content file request, it may be designated that the distribution of the bitstream of the segmented region 12 is prioritized over the distribution of the bitstream of the partial region 121. For example, in a case where a request for generation with priority on a data size (only the requested segmented region 12) is made, the file acquisition unit 181 of the client apparatus 113 may add “priority_size_req” to the URL parameter. Then, in a case where the “priority_size_req” is added to the request, the generation unit 153 of the distribution server 112 may generate the bitstream of the segmented region 12 instead of generating the bitstream of the partial region 121 in accordance with a situation. For example, the generation unit 153 may generate the bitstream of the requested segmented region 12 in a case where there is a margin in a processing load of the distribution server 112, and may generate the bitstream of the partial region 121 including the requested segmented region 12 in a case where there is no margin in the load.

Note that, in a case where “priority_size_req” is not added to this URL parameter, the generation unit 153 does not generate the segmented region 12 but generates only the bitstream of the partial region 121.

For example, the file acquisition unit 181 of the client apparatus 113 may generate a request for a content file including a parameter designating that distribution of a bitstream of the segmented region 12 that is desired to be acquired is prioritized.

Then, for example, the generation unit 153 may generate a bitstream of a partial region in a case where a bitstream of a subpicture is requested, and may generate a bitstream of a segmented region by decoding a bitstream of a picture, segmenting the segmented region from the picture, and encoding the segmented region in a case where the bitstream of the segmented region is requested.

In this manner, it is possible to further suppress the increase in the data transmission amount from the distribution server 112 to the client apparatus 113.

Furthermore, in a case where content to be distributed is a 360-degree video, the segmented region 12 that is desired to be acquired may be designated using a parameter related to a display region (Viewport) in the content file request. The parameter related to the display region is arbitrary as in the case of Method 1-1-1.

For example, the file acquisition unit 181 of the client apparatus 113 may generate a request for a content file including a parameter related to a display region (Viewport), the request designating the segmented region 12 that is desired to be acquired. In other words, the generation unit 153 of the distribution server 112 may identify the subpictures 11 including the segmented region 12 designated using information regarding the display region in the content file request, select metadata that can merge the identified subpictures 11, merge bitstreams of the identified subpictures 11 using the selected metadata, and generate a bitstream of the partial region 121 constituted by the merged subpicture 11.

### Method 2-1-2

In a case where the above-described Method 2-1 is applied, as illustrated in the fifth row from the top of the table illustrated in FIG. 20, in the above-described content file request (request from the client apparatus 113 to the distribution server 112), a group id of a region including a necessary portion may be specified from a trif sample group in a VVC track (Method 2-1-2). As in the case of Method 1-1-2, group_id indicating region including a necessary portion is added as a URL parameter.

For example, the file acquisition unit 181 of the client apparatus 113 may generate a content file request including identification information (group_id) for identifying a region of the trif sample group. In other words, the generation unit 153 of the distribution server 112 may generate a bitstream of the partial region 121 by selecting metadata (VVC merge base track 312) that can merge regions designated using the identification information (group_id) in the request and merging the regions (VVC subpicture tracks 313) using the selected metadata.

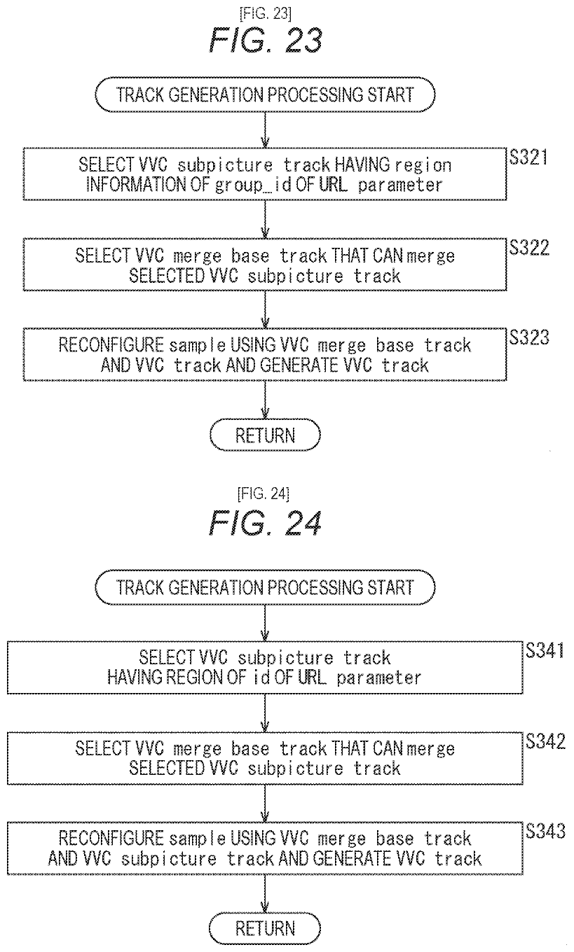

An example of a flow of track generation processing executed by the generation unit 153 of the distribution server 112 in step S123 of FIG. 10 in that case will be described with reference to a flowchart of FIG. 23.

In step S321, the generation unit 153 of the distribution server 112 selects a content file (VVC subpicture track 313) storing a bitstream of region information of group_id of the URL parameter included in the content file request, and reads the content file from the storage unit 152. That is, the subpictures 11 are selected by regions indicated by group_id, and the VVC subpicture tracks 313 that store the bitstream is selected.

In step S322, the generation unit 153 of the distribution server 112 selects metadata (VVC merge base track 312) that can merge the selected subpictures 11 (VVC subpicture tracks 313), and reads the metadata from the storage unit 152. In step S323, the generation unit 153 reconfigures a sample using the read VVC merge base track 312 and the VVC subpicture tracks 313, and generates a bitstream of the partial region 121 including the segmented region 12. That is, the generation unit 153 generates the bitstream of the partial region 121 by merging the selected bitstreams of the subpictures 11 on the basis of the VVC merge base track 312. Then, the generation unit 153 newly generates a content file (VVC track) and stores the bitstream of the partial region 121 therein. When the process of step S323 ends, the track generation processing ends, and the processing returns to FIG. 10.

In this manner, the distribution server 112 can suppress the increase in the processing load.

Note that, instead of the above-described group id, a region including a necessary portion may be designated using subpic_id of a spid sample group. “subpic_id” is identification information for identifying the subpicture 11.

For example, the file acquisition unit 181 of the client apparatus 113 may generate a content file request including identification information (subpic_id) indicating the subpicture 11. In other words, the generation unit 153 of the distribution server 112 may generate a bitstream of the partial region 121 by selecting metadata (VVC merge base track 312) that can merge the subpictures 11 (VVC subpicture tracks 313) designated using the identification information (subpic_id) in the request and merging the designated subpictures 11 (VVC subpicture tracks 313) using the selected metadata.

### Method 2-1-3

In a case where the above-described Method 2-1 is applied, as illustrated in the sixth row from the top of the table illustrated in FIG. 20, regionInfo of a supplemental property indicating region information may be added to an adaptation set of a content file (VVC track) in an MPD file (Method 2-1-3). For example, as illustrated in FIG. 16, a region and its identification information (region id) are defined in the MPD file, and the region including the segmented region 12 is designated using the identification information in a request for the content file.

For example, the preprocessing unit 142 of the file generation apparatus 111 may generate the description as illustrated in FIG. 16 as partial region file generation information, and the file generation unit 144 may store the description in a control file (MPD file) that controls distribution of the content file. Furthermore, the file acquisition unit 181 of the client apparatus 113 may generate a content file request including identification information (region id) defined in a control file (MPD file) that controls distribution of the content file. That is, the file acquisition unit 181 may designate the region id of the region including the segmented region 12 in the request. Moreover, the generation unit 153 of the distribution server 112 may generate a bitstream of the partial region 121 by selecting metadata (VVC merge base track 312) that can merge the subpictures 11 constituting the partial region 121 including the region designated using the identification information (region id) defined in the control file (MPD file) that controls distribution of the content file and merging the subpictures 11 (VVC subpicture tracks 313) using the selected metadata.

An example of a flow of track generation processing executed by the generation unit 153 of the distribution server 112 in step S123 of FIG. 10 in this case will be described with reference to a flowchart of FIG. 24.

In step S341, the generation unit 153 of the distribution server 112 selects a region (VVC subpicture track 313) indicated by id of a URL parameter included in a request for a content file, and reads the region from the storage unit 152. In step S342, the generation unit 153 selects metadata (VVC merge base track 312) that can merge the selected subpictures 11, and reads the metadata from the storage unit 152. In step S343, the generation unit 153 reconfigures a sample using the read VVC merge base track 312 and the VVC subpicture track 313, and generates a bitstream of the partial region 121 including the segmented region 12. That is, the generation unit 153 generates the bitstream of the partial region 121 by merging bitstreams of the subpictures 11 indicated by the region on the basis of the VVC merge base track 312. Then, the generation unit 153 newly generates a content file (VVC track) and stores the bitstream of the partial region 121 therein. When the process of step S343 ends, the track generation processing ends, and the processing returns to FIG. 10.

In this manner, the client apparatus 113 can more reliably designate the partial region 121 that can be extracted by the distribution server 112.

Note that, in the content file request, information on the acquirable partial region 121 defined in the MPD may be described instead of the identification information defined in the MPD. In this case, in the MPD file, an adaptation set is described for each combination of partial regions that can be acquired. For example, an adaptation set is defined for each combination of partial regions, such as an adaptation set of partial regions A+B or an adaptation set of partial regions A+C. Therefore, a partial region to be requested is designated by a URL in the content file request. That is, no URL parameter is added. The generation unit 153 of the distribution server 112 generates a VVC track including the entire region of regionInfo corresponding to the designated URL.

For example, the generation unit 153 of the distribution server 112 may generate a bitstream of the partial region 121 by selecting metadata (VVC merge base track 312) that can merge the subpictures 11 constituting the partial region specified in the content file request among partial regions defined as the adaptation set in the control file (MPD file) that controls distribution of the content file and merging the subpictures 11 (VVC subpicture tracks 313) using the selected metadata.

### Method 2-2

In a case where Method 2 is applied, as illustrated in the bottom row of the table illustrated in FIG. 20, partial region file generation information may be stored in the VVC merge base track (Method 2-2). For example, the partial region file generation information may include information indicating that the distribution server 112 can apply the above-described Method 2 and generate a bitstream of a partial region. In other words, the preprocessing unit 142 of the file generation apparatus 111 may generate the partial region file generation information including the information indicating that the bitstream of the partial region 121 can be generated in the distribution server 112.

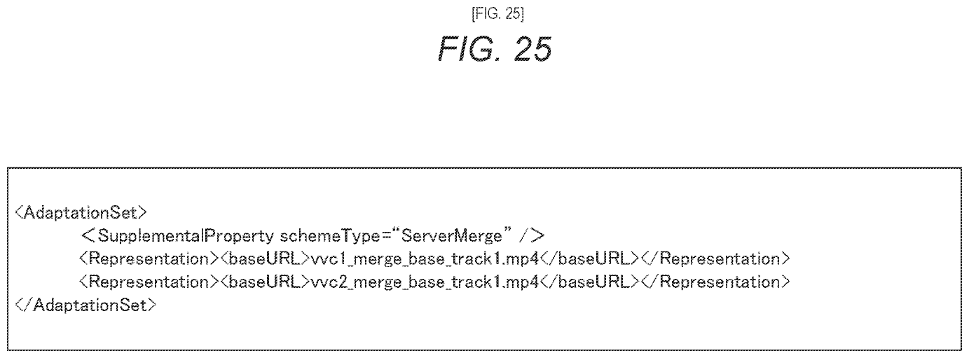

For example, a description as illustrated in FIG. 25 may be stored in an adaptation set corresponding to metadata (VVC merge base track 312) for extracting the subpicture 11 in an MPD file. That is, metadata (schemeType=“ServerMerge”) indicating that a bitstream of the partial region 121 can be generated in the distribution server 112 may be described in a supplemental property (SupplementalProperty). With such a description, the file processing unit 182 of the client apparatus 113 that analyzes the MPD file can grasp that the distribution server 112 can generate the bitstream of the partial region 121 by using the metadata (VVC merge base track 312) on the basis of the description. Then, on the premise of such grasping, the file acquisition unit 181 can request the distribution server 112 for a bitstream of a region including at least the segmented region 12. That is, the file acquisition unit 181 can make a request that can be handled by the distribution server 112. Therefore, the distribution server 112 can more reliably perform processing in response to a request from the client apparatus 113.

That is, in this case, the file acquisition unit 181 of the client apparatus 113 designates the partial region 121 to be requested by designating the metadata (VVC merge base track 312) to be used by the distribution server 112 in the content file request. For example, in the content file request, the file acquisition unit 181 of the client apparatus 113 designates the metadata (VVC merge base track 312) to be used by the distribution server 112 using a URL as described below, and adds the following URL parameter to the URL.

http://hoge.com/vvc_merge_base_track.mp4?ServerMerge

In this description, “http://hoge.com/vvc_merge_base_track.mp4” indicates an example of the URL that designates the metadata (VVC merge base track 312) for merging subpictures. “ServerMerge” is a URL parameter for requesting merge of the subpictures 11.

Then, in a case where the URL parameter is added, the generation unit 153 of the distribution server 112 merges the subpictures 11 using the metadata (VVC merge base track 312) designated by the URL. For example, the generation unit 153 of the distribution server 112 may generate a bitstream of the partial region 121 by merging the subpictures 11 using the metadata (VVC merge base track 312) for merging the subpictures 11 designated in the content file request.

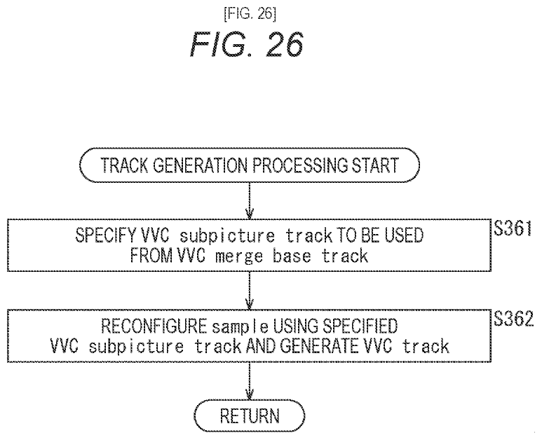

An example of a flow of track generation processing executed by the generation unit 153 of the distribution server 112 in step S123 of FIG. 10 in this case will be described with reference to a flowchart of FIG. 26.

In step S361, the generation unit 153 of the distribution server 112 specifies the subpictures 11 (VVC subpicture tracks 313) to be used from metadata (VVC merge base track 312) designated in a content file request. In step S362, the generation unit 153 reconfigures a sample using the specified subpictures 11 (VVC subpicture tracks 313), and generates a bitstream of the partial region 121 including the segmented region 12. That is, the generation unit 153 extracts the bitstream of the partial region 121 by merging the subpictures 11 using the VVC merge base track 312 designated in the content file request. Then, the generation unit 153 newly generates a content file (VVC track) and stores the bitstream of the partial region 121 therein. That is, the generation unit 153 merges the specified subpictures 11 (VVC subpicture tracks 313). When the process of step S362 ends, the track generation processing ends, and the processing returns to FIG. 10.

In this manner, the VVC track of a region that can be generated by the distribution server 112 can be clearly indicated to the client apparatus 113.

Note that track_id may be designated in a content file request. The VVC extraction base track 163 may be capable of selecting a track that can be merged. In this case, a track to be merged may be designated using track_id. For example, a case where track_id=1 and 2 are acquired is described as follows.

http://hoge.com/vvc_merge_base_track.mp4?ServerMerg e&track_id=1&track_id=2

In this description, “http://hoge.com/vvc_merge_base_track.mp4” indicates an example of a URL that designates the content file to be requested. “ServerMerge” is a URL parameter for requesting the distribution server 112 to perform merge processing. “track_id=1 & track_id=2” is a URL parameter indicating a partial region corresponding to track_id=1 and a partial region corresponding to track_id=2. Note that the URL parameter “ServerMerge” may be omitted.

Furthermore, an adaptation set dedicated to ServerMerge may be described in an MPD file. In that case, as described below, the designation is performed not by the sample property (Supplemental property) but by an essential property (EssentialProperty). The URL for ServerMerge is designated.

<EssentialProperty schemeType=“ServerMerge”/>

In this case, the addition of the URL parameter (ServerMerge) described above in Method 2-2 can be omitted. Furthermore, track_id may be designated in a content file request. In a case where a file indicated by this adaptation set is accessed, the file is treated as if it is in the distribution server 112.

### 5. Partial Region Information

### Method 3

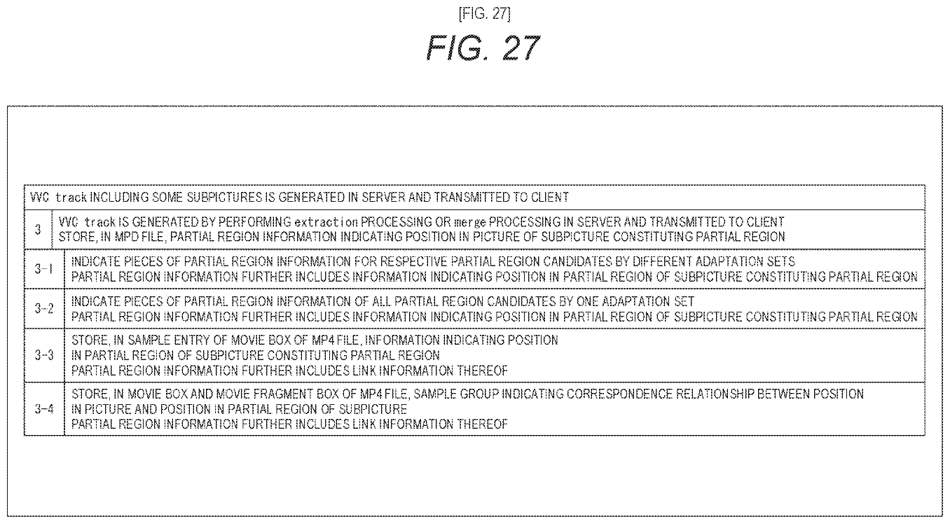

Information indicating a position of the partial region 121 distributed from the distribution server 112 to the client apparatus 113 in the original picture 10 may be stored in an MPD file as partial region information. For example, as illustrated in the second row from the top of the table in FIG. 27, information indicating positions of the subpictures 11 constituting the partial region 121 in the picture 10 may be stored in the MPD file (Method 3). Note that, in this case, the distribution server 112 may apply the above-described Method 1 to generate a VVC track by processing (extraction processing) of extracting the partial region 121 from the picture 10, or may apply the above-described Method 2 to generate a VVC track by merge processing of merging the subpictures 11. That is, Method 3 may be applied to both Method 1 (including the respective methods described with reference to FIG. 4) and Method 2 (including the respective methods described with reference to FIG. 20).

For example, the preprocessing unit 142 (partial region file generation information generation unit) of the file generation apparatus 111 may further generate partial region information indicating positions of subpictures 11 constituting the partial region 121 in the picture 10 that is a moving image. Then, the file generation unit 144 may store the partial region information in an MPD file (control file).

Furthermore, the display information generation unit 184 (segmentation unit) of the client apparatus 113 segments the segmented region 12 from the partial region 121, distributed from the distribution server 112, on the basis of the partial region information included in the MPD file (control file), and generates display information (a display image or the like).

For example, as illustrated in FIG. 1, in a case where the segmented region 12 related to a plurality of subpictures 11 and partial region 121 is constituted by the plurality of subpictures, a positional relationship of each of the subpictures in the partial region 121 may be different from a positional relationship of each of the subpictures in the original picture 10. Since the segmented region 12 is formed according to the positional relationship in the original picture 10, in a case where the above positional relationships are different from each other, there is a possibility that the segmented region 12 cannot be correctly segmented when the display information generation unit 184 of the client apparatus 113 follows the positional relationship in the partial region 121.

As the partial region information is provided to the client apparatus 113 as described above, the display information generation unit 184 of the client apparatus 113 can grasp the position of the subpicture 11 constituting the partial region 121 in the original picture 10 on the basis of the partial region information. Therefore, display information generation unit 184 can correctly segment the segmented region 12 regardless of the positional relationship of the subpicture 11 in the partial region 121. In other words, the display information generation unit 184 can correctly segment the segmented region 12 regardless of the positional relationship of the subpicture constituting the partial region in the original picture 10.

In a case where Method 3 is applied, partial region information may include any information as long as the partial region information includes information indicating a position of the subpicture 11 constituting the partial region 121 in the picture 10 that is a moving image. For example, the partial region information may include information indicating a position of an upper end of the subpicture 11 in the picture 10. Furthermore, the partial region information may include information indicating a position of a left end of the subpicture 11 in the picture 10.

Furthermore, the partial region information may further include information indicating a size of the subpicture 11. For example, the partial region information may further include information indicating a size of the subpicture 11 in the vertical direction. Furthermore, the partial region information may further include information indicating a size of the subpicture 11 in the horizontal direction.

Furthermore, the partial region information may further include information indicating a position of the subpicture 11 in the partial region 121. For example, the partial region information may further include information indicating a position of an upper end of the subpicture 11 in the partial region 121. Furthermore, the partial region information may further include information indicating a position of a left end of the subpicture 11 in the partial region 121.

### Method 3-1

In a case where Method 3 is applied, as illustrated in the third row from the top of the table illustrated in FIG. 27, partial region information may be indicated by differentiating an adaptation set for each candidate for the partial region 121 in a control file (MPD file). Furthermore, the partial region information may further include information indicating a position in a partial region of a subpicture constituting the partial region 121 (Method 3-1).

For example, the file generation unit 144 of the file generation apparatus 111 may store pieces of the partial region information of the respective candidates for the partial region 121 in mutually different adaptation sets of the MPD file.

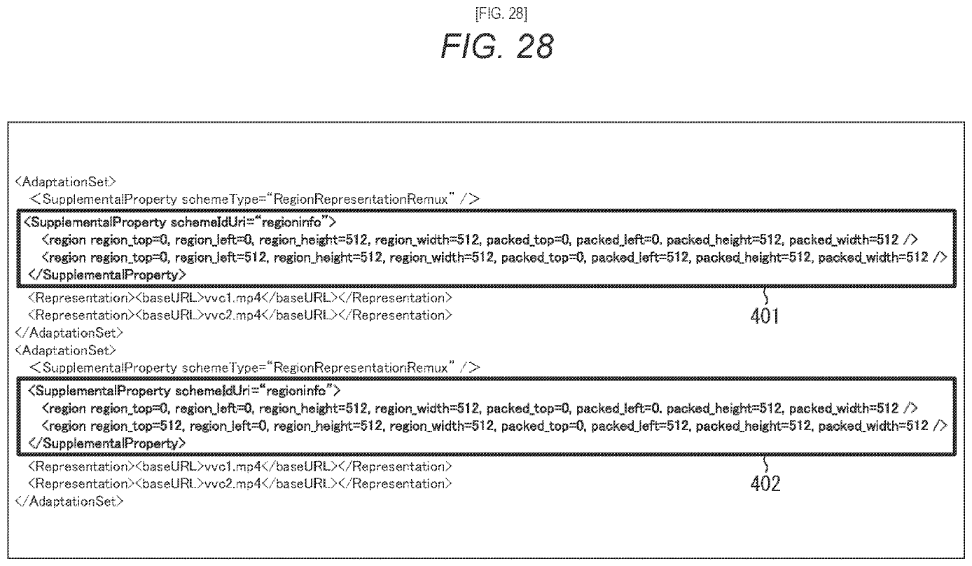

FIG. 28 is a view illustrating a description example of a part of the MPD file in that case. In a case where the picture 10 is constituted by a plurality of the subpictures 11, a plurality of combinations of the subpictures 11 constituting the partial region 121 (including a case where the single subpicture 11 constitutes the partial region 121) can be considered. The respective combinations are set as the respective candidates for the partial region 121, and the partial region information is stored for each of the candidates in the MPD file. That is, in the MPD file, a position of each of the subpictures 11 in the partial region 121 is indicated for each of the combinations of the subpictures 11 selectable as the partial region 121.

A description example indicated inside a square frame 401 in FIG. 28 indicates a description example of partial region information of one candidate. Similarly, a description example indicated inside a square frame 402 indicates a description example of partial region information of another candidate. In this description example, Method 3-1 is applied. Therefore, the partial region information indicated inside the square frame 401 and the partial region information indicated inside the square frame 402 are stored in mutually different adaptation sets. That is, in the case of this description example, pieces of the partial region information of the respective candidates for the partial region 121 are stored in mutually different adaptation sets of the MPD file.

In the description example indicated inside the square frame 401 and the description example indicated inside the square frame 402 in FIG. 28, a value of region_top indicates a position (coordinate in the vertical direction (y coordinate)) of an upper end of the subpicture 11 in the picture 10. A value of region_left indicates a position (coordinate in the horizontal direction (x coordinate)) of a left end of the subpicture 11 in the picture 10. A value of region_height indicates a size (height) in the vertical direction of the subpicture 11 in the picture 10. A value of region_width indicates a size (width) in the horizontal direction of the subpicture 11 in the picture 10. Furthermore, a value of packed_top indicates a position (coordinate in the vertical direction (y coordinate)) of an upper end of the subpicture 11 in the partial region 121. A value of packed_left indicates a position (coordinate in the horizontal direction (x coordinate)) of a left end of the subpicture 11 in the partial region 121. A value of packed_height indicates a size (height) in the vertical direction of the subpicture 11 in the partial region 121. A value of packed_width indicates a size (width) in the horizontal direction of the subpicture 11 in the partial region 121.

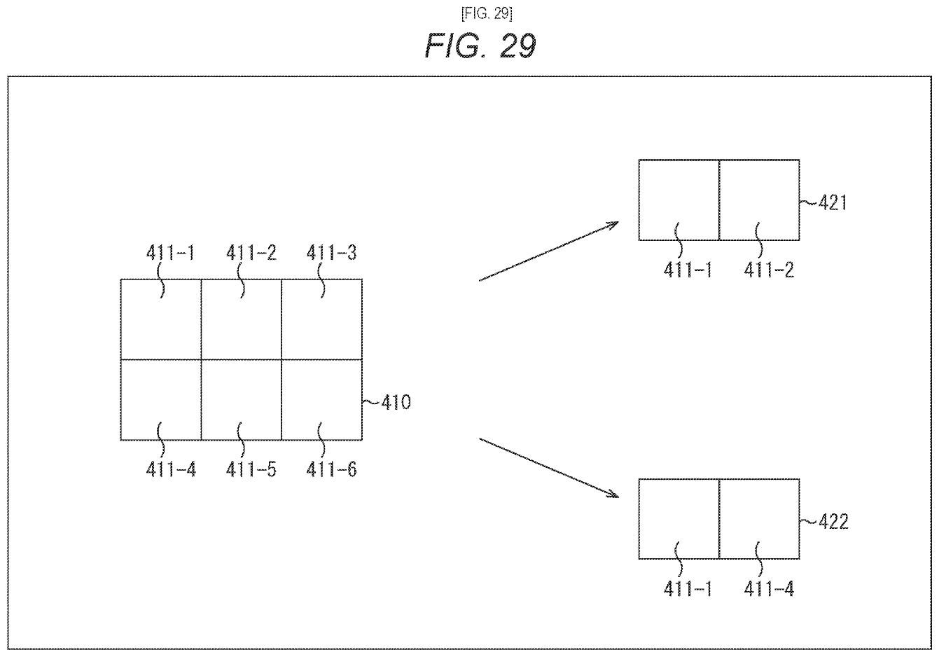

For example, as illustrated in FIG. 29, it is assumed that a picture 410 is constituted by subpictures 411-1 to 411-6. In a case where it is not necessary to describe the subpictures 411-1 to 411-6 to be distinguished from each other, they are referred to as subpictures 411. A size of each of the subpictures 411 is assumed to be height 512×width 512.

The description example in FIG. 28 indicates that a partial region 421 including the subpicture 411-1 and the subpicture 411-2 and a partial region 422 including the subpicture 411-1 and the subpicture 411-4 can be generated from such a picture 410. That is, the partial region 421 and the partial region 422 are set as candidates, and partial region information is illustrated for each of them.

For example, the description example indicated inside the square frame 401 indicates that the partial region 421 is constituted by a first subpicture (the second line) of which coordinates of an upper left end are (0, 0) (packed_top=0, packed_left=0) and size is 512×512 (packed_height=512, packed_width=512), and a second subpicture (the third line) of which coordinates of an upper left end are (512, 0) (packed_top=0, packed_left=512) and size is 512×512 (packed_height=512, packed_width=512). Then, it is indicated that coordinates of an upper left end of the first subpicture in the picture 410 are (0, 0) (region_top=0, region_left=0), and a size of the first subpicture in the picture 410 is 512×512 (region_height=512, region_width=512). Similarly, it is indicated that coordinates of an upper left end of the second subpicture in the picture 410 are (512, 0) (region_top=0, region_left=512), and a size of the second subpicture in the picture 410 is 512×512 (region_height=512, region_width=512). That is, it is indicated that this candidate (the partial region 421) is constituted by the subpicture 411-1 and the subpicture 411-2 arranged side by side in the horizontal direction as illustrated in the upper right of FIG. 29.

On the other hand, the description example indicated inside the square frame 402 indicates that the partial region 422 is constituted by a first subpicture (the second line) of which coordinates of an upper left end are (0, 0) (packed_top=0, packed_left=0) and size is 512×512 (packed_height=512, packed_width=512), and a second subpicture (the third line) of which coordinates of an upper left end are (512, 0) (packed_top=0, packed_left=512) and size is 512×512 (packed_height=512, packed_width=512). Then, it is indicated that coordinates of an upper left end of the first subpicture in the picture 410 are (0, 0) (region_top=0, region_left=0), and a size of the first subpicture in the picture 410 is 512×512 (region_height=512, region_width=512). Similarly, it is indicated that coordinates of an upper left end of the second subpicture in the picture 410 are (0, 512) (region_top=512, region_left=0), and a size of the second subpicture in the picture 410 is 512×512 (region_height=512, region_width=512). That is, it is indicated that this candidate (the partial region 422) is constituted by the subpicture 411-1 and the subpicture 411-4 arranged side by side in the horizontal direction as illustrated in the upper right of FIG. 29.

As in these examples of the partial region 421 and the partial region 422, when it is unknown whether the subpictures 11 constituting the partial region 121 are arranged horizontally or vertically in the picture 10, (the display information generation unit 184 of) the client apparatus 113 does not know how to segment the segmented region 12 from the partial region 121 (it is difficult to correctly segment the segmented region 12).

However, the client apparatus 113 requests the distribution server 112 to distribute the partial region 121 selected from the candidates as described above. That is, partial region information indicates positions of the subpictures 11 constituting the partial region 121 supplied from the distribution server 112 to the client apparatus 113 in the picture 10.

Therefore, the client apparatus 113 can grasp the position of each of the subpictures 11 constituting the partial region 121 in the picture 10 by referring to the partial region information. For example, in the case of FIG. 28, on the basis of the partial region information, the client apparatus 113 can grasp whether the partial region 121 is constituted by the subpictures 11 arranged horizontally in the picture 10 (that is, the subpicture 411-1 and the subpicture 411-2 in FIG. 29) or is constituted by the subpictures 11 arranged vertically in the picture 10 (that is, the subpicture 411-1 and the subpicture 411-4 in FIG. 29).

Therefore, (the display information generation unit 184 of) the client apparatus 113 can correctly segment a segmented region from the partial region 121 even in a case where the segmented region relates to the plurality of subpictures 11 of the picture 10. That is, as the file generation apparatus 111 generates the partial region information as described above and provides the partial region information being stored in the MPD file to the client apparatus 113, (the display information generation unit 184 of) the client apparatus 113 can correctly segment the segmented region from the partial region 121.

Note that Method 3-1 can be applied in a case where any one of Method 1-1-2, Method 1-1-3, Method 2-1-2, and Method 2-1-3 described above is applied.

### Flow of File Generation Processing

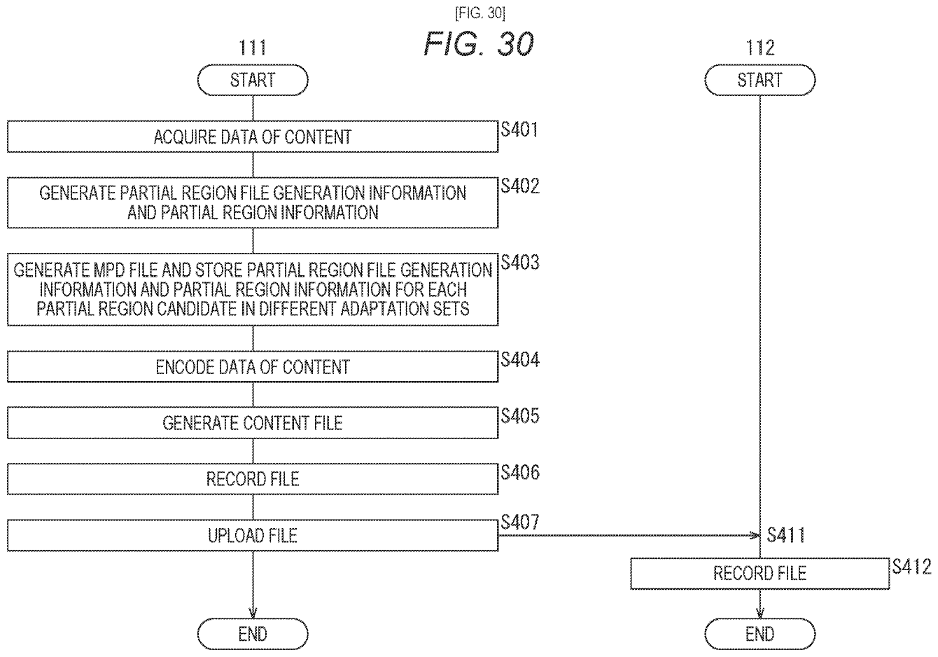

An example of a flow of processing (file generation processing) until the file generation apparatus 111 generates a file and uploads the file to the distribution server 112 in a case where the above-described Method 3-1 is applied will be described with reference to a flowchart of FIG. 30.

When the processing is started, the input unit 141 of the file generation apparatus 111 acquires data of content including a moving image in step S401.

In step S402, the preprocessing unit 142 generates partial region file generation information for generating a file that stores a bitstream of the partial region 121 of the picture 10 on the basis of the data of the moving image. Furthermore, the preprocessing unit 142 generates metadata for generating the bitstream of the partial region constituted by a subpicture on the basis of the data of the moving image. Moreover, the preprocessing unit 142 applies the above-described Method 3-1 to generate partial region information indicating a position of the subpicture 11 constituting the partial region 121 in the picture 10.

In step S403, the file generation unit 144 generates an MPD file which is a control file for controlling distribution of a content file, and stores the partial region file generation information generated in step S402 in the MPD file. Furthermore, the file generation unit 144 also stores the partial region information generated in step S402 in the MPD file by applying the above-described Method 3-1. At that time, the file generation unit 144 stores pieces of the partial region information of the respective candidates for the partial region 121 in mutually different adaptation sets of the MPD file. Furthermore, the file generation unit 144 generates a metadata file and stores the metadata generated in step S402 in the metadata file.

The respective processes of steps S404 to S407 are executed as in the respective processes of steps S104 to S107 of FIG. 9. Furthermore, each process of step S411 and step S412 is executed similarly to each process of step S111 and step S112 of FIG. 9.

### Flow of Content Distribution Processing

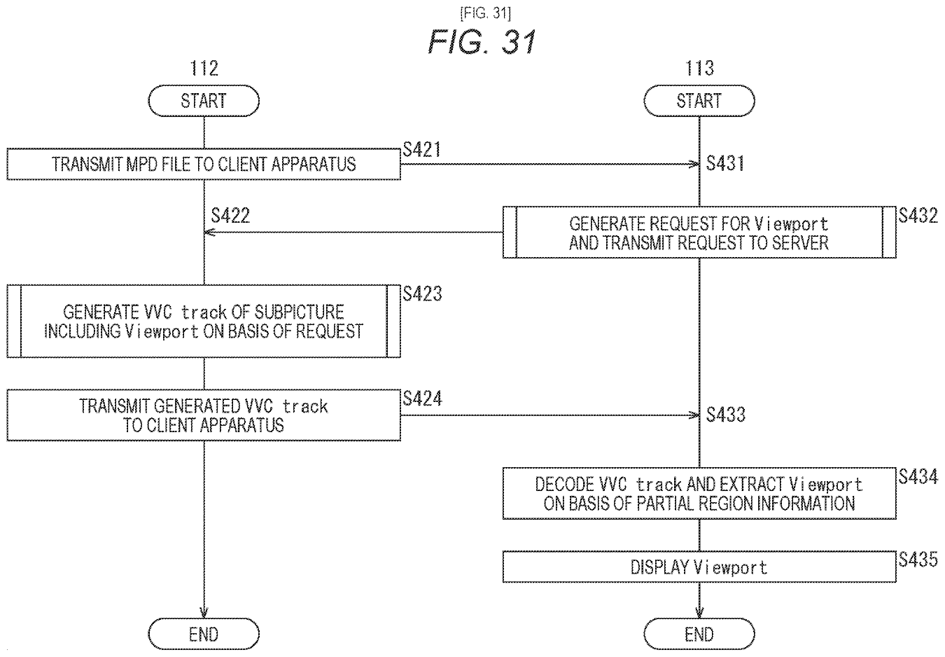

An example of a flow of processing (content distribution processing) in which the distribution server 112 of the content distribution system 100 distributes content to the client apparatus 113 in a case where the above-described Method 3-1 is applied will be described with reference to a flowchart of FIG. 31.

When the processing is started, in the distribution server 112, the respective processes of steps S421 to S424 are executed as in the respective processes of steps S121 to S124 of FIG. 10. Furthermore, in the client apparatus 113, the respective processes of steps S431 to S433 are executed as in the processes of steps S131 to S133 of FIG. 10.

In step S434, the file processing unit 182 extracts a bitstream of the partial region 121 from a received content file. The decoding unit 183 decodes the bitstream of the partial region 121 to generate image data of the partial region 121. The display information generation unit 184 applies the above-described Method 3-1, and segments the segmented region 12 from the partial region 121 on the basis of partial region information stored in an MPD file.

In step S435, the display unit 185 displays the segmented region 12 as a display region.

As the respective processes are executed as described above, the file generation apparatus 111 can generate the partial region information, store the partial region information in the MPD file, and provide the MPD file to the client apparatus 113. Furthermore, the client apparatus 113 can acquire and store the MPD file. That is, the file generation apparatus 111 can provide the partial region information to the client apparatus 113. Furthermore, the client apparatus 113 can receive and decode the bitstream of the partial region 121 distributed from the distribution server 112. Then, the client apparatus 113 can segment the segmented region 12 from the partial region on the basis of the partial region information stored in the stored MPD file.

Therefore, the client apparatus 113 can correctly segment the segmented region 12 on the basis of the partial region information.

### Modified Examples

Note that, in partial region information in a case where Method 3-1 is applied as described above, a position and a size of the subpicture 11 constituting each candidate for the partial region 121 in the picture 10 may be indicated using group_id of a trif sample group. That is, this group_id may be used instead of parameters such as region_top, region_left, region_height, and region_width. Furthermore, a position and a size of the subpicture 11 constituting each candidate for the partial region 121 in the picture 10 may be indicated using subpic_id of a spid sample group. That is, this subpic_id may be used instead of parameters such as region_top, region_left, region_height, and region_width.

### Method 3-2

In a case where Method 3 is applied, as illustrated in the fourth row from the top of the table illustrated in FIG. 27, pieces of partial region information of all candidates of the partial region 121 may be indicated in one adaptation set in a control file (MPD file). Furthermore, the partial region information may further include information indicating a position in the partial region 121 of the subpicture 11 constituting the partial region 121 (Method 3-2).

For example, the file generation unit 144 of the file generation apparatus 111 may store pieces of the partial region information of the respective candidates for the partial region 121 in one adaptation set of the MPD file.

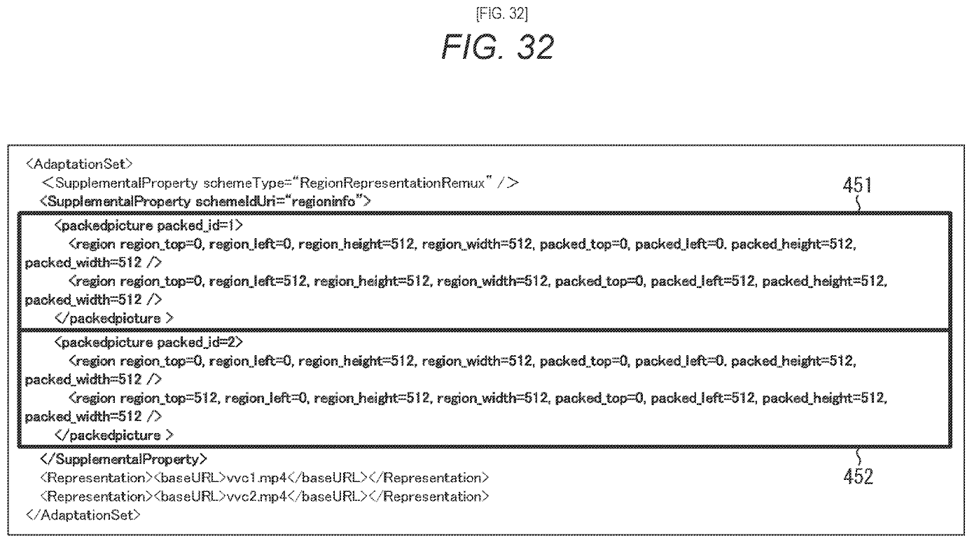

FIG. 32 is a view illustrating a description example of a part of the MPD file in that case. A description example indicated inside a square frame 451 indicates a description example of partial region information of one candidate. Similarly, a description example indicated inside a square frame 452 indicates a description example of partial region information of another candidate. In this description example in FIG. 32, Method 3-2 is applied. Therefore, the partial region information indicated inside the square frame 451 and the partial region information indicated inside the square frame 452 are stored in the same adaptation set. That is, in the case of this description example, pieces of the partial region information of the respective candidates for the partial region 121 are stored in one adaptation set of the MPD file.

Information indicated by values of parameters (region_top, region_left, region_height, region_width, packed_top, packed_left, packed_height, packed_width) in the description example illustrated in the square frame 451 and the description example illustrated in the square frame 402 of FIG. 32 is similar to that in the case of the description example illustrated in FIG. 28.

For example, as illustrated in FIG. 29, it is assumed that the picture 410 is constituted by the six subpictures 411 (subpictures 411-1 to 411-6), and the size of each of the subpictures 411 is height 512×width 512. In the description example illustrated inside the square frame 451 in FIG. 32, similarly to the description example illustrated inside the square frame 401 in FIG. 28, it is indicated that the partial region 421 is constituted by the subpicture 411-1 and the subpicture 411-2 arranged side by side in the horizontal direction (the upper right example in FIG. 29). On the other hand, in the description example illustrated inside the square frame 452, similarly to the description example illustrated inside the square frame 402 in FIG. 28, it is indicated that the partial region 422 is constituted by the subpicture 411-1 and the subpicture 411-4 arranged side by side in the horizontal direction (the lower right example in FIG. 29).

The client apparatus 113 selects any combination of packed pictures and makes a request therefor. At that time, the client apparatus 113 may make the request as in Method 1-1-3 or Method 2-1-3. In this case, packed_id may be used for the request.

That is, similarly to the case where Method 3-1 is applied, the client apparatus 113 can grasp a position of each of the subpictures 11 constituting the partial region 121 in the picture 10 by referring to the partial region information. Therefore, (the display information generation unit 184 of) the client apparatus 113 can correctly segment a segmented region from the partial region 121 even in a case where the segmented region relates to the plurality of subpictures 11 of the picture 10. That is, as the file generation apparatus 111 generates the partial region information as described above and provides the partial region information being stored in the MPD file to the client apparatus 113, (the display information generation unit 184 of) the client apparatus 113 can correctly segment the segmented region from the partial region 121.

Furthermore, in the case of Method 3-2, even in a case where the partial region 121 varies along the time axis, the partial region information can be stored in one adaptation set.

Note that Method 3-2 can be applied in a case where any one of Method 1-1-2, Method 1-1-3, Method 2-1-2, and Method 2-1-3 described above is applied.

### Flow of File Generation Processing

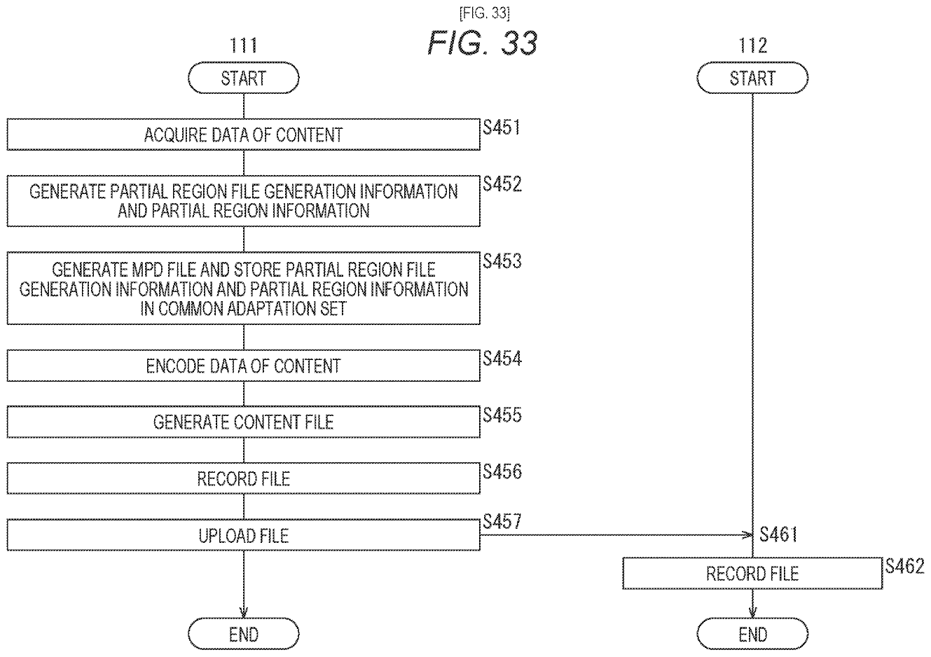

An example of a flow of processing (file generation processing) until the file generation apparatus 111 generates a file and uploads the file to the distribution server 112 in a case where the above-described Method 3-2 is applied will be described with reference to a flowchart of FIG. 33.

When the processing is started, the input unit 141 of the file generation apparatus 111 acquires data of content including a moving image in step S451.

In step S452, the preprocessing unit 142 generates partial region file generation information for generating a file that stores a bitstream of the partial region 121 of the picture 10 on the basis of the data of the moving image. Furthermore, the preprocessing unit 142 generates metadata for generating the bitstream of the partial region constituted by a subpicture on the basis of the data of the moving image. Moreover, the preprocessing unit 142 applies the above-described Method 3-2 to generate partial region information indicating a position of the subpicture 11 constituting the partial region 121 in the picture 10.

In step S453, the file generation unit 144 generates an MPD file which is a control file for controlling distribution of a content file, and stores the partial region file generation information generated in step S452 in the MPD file. Furthermore, the file generation unit 144 also stores the partial region information generated in step S452 in the MPD file by applying the above-described Method 3-2. At that time, the file generation unit 144 stores pieces of the partial region information of the respective candidates for the partial region 121 in one adaptation set of the MPD file. Furthermore, the file generation unit 144 generates a metadata file and stores the metadata generated in step S452 in the metadata file.

The respective processes of steps S454 to S457 are executed as in the respective processes of steps S104 to S107 of FIG. 9. Furthermore, each process of step S461 and step S462 is executed similarly to each process of step S111 and step S112 of FIG. 9.

Note that the flow of the content distribution processing in the case of applying the above-described Method 3-2 is similar to the case of applying Method 3-1 (FIG. 31).

As the respective processes are executed as described above, the file generation apparatus 111 can generate the partial region information, store the partial region information in the MPD file, and provide the MPD file to the client apparatus 113. Furthermore, the client apparatus 113 can acquire and store the MPD file. That is, the file generation apparatus 111 can provide the partial region information to the client apparatus 113. Furthermore, the client apparatus 113 can receive and decode the bitstream of the partial region 121 distributed from the distribution server 112. Then, the client apparatus 113 can segment the segmented region 12 from the partial region on the basis of the partial region information stored in the stored MPD file.

Therefore, the client apparatus 113 can correctly segment the segmented region 12 on the basis of the partial region information.

### Modified Examples

Note that, in partial region information in a case where Method 3-2 is applied as described above, a position and a size of the subpicture 11 constituting each candidate for the partial region 121 in the picture 10 may be indicated using group_id of a trif sample group. That is, this group_id may be used instead of parameters such as region_top, region_left, region_height, and region_width. Furthermore, a position and a size of the subpicture 11 constituting each candidate for the partial region 121 in the picture 10 may be indicated using subpic_id of a spid sample group. That is, this subpic_id may be used instead of parameters such as region_top, region_left, region_height, and region_width.

### Method 3-3

In a case where Method 3 is applied, as illustrated in the fifth row from the top of the table illustrated in FIG. 27, information indicating a position in the partial region 121 of the subpicture 11 constituting the partial region 121 may be stored in a content file (for example, a sample entry of a movie box of an MP4 file). Then, partial region information stored in a control file (MPD file) may further include link information (link information with respect to information that is stored in the content file and indicates the position in the partial region 121 of the subpicture 11 constituting the partial region 121) (Method 3-3).

For example, the file generation unit 144 of the file generation apparatus 111 may further generate a content file, and store information indicating the position of the subpicture 11 in the partial region 121 in the content file. For example, the file generation unit 144 may store the information indicating the position of the subpicture 11 in the partial region 121 in a sample entry of a movie box of the content file (MP4 file). Furthermore, the partial region information may further include link information with respect to the information indicating the position of the subpicture 11 in the partial region 121.

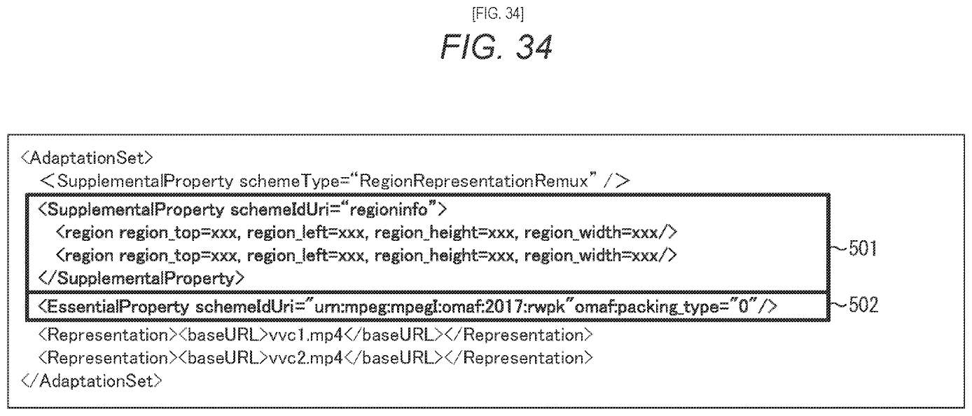

FIG. 34 is a view illustrating a description example of a part of the MPD file in that case. In FIG. 34, the partial region information is stored inside a square frame 501 and a square frame 502. For example, information (region_top, region_left, region_height, region_width) indicating the position of the subpicture 11 constituting the candidate for the partial region 121 in the picture 10 is stored inside the square frame 501. Note that the information indicated by values of these parameters is similar to that in the case of the description example illustrated in FIG. 28.

Furthermore, link information with respect to information (information indicating a position of the subpicture 11 in the partial region 121) stored in a content file (a sample entry of a movie box of an MP4 file) is stored inside the square frame 502. For example, a region-wise packing box defined in OMAF may be stored in the MP4 file below the sample entry below the movie box (‘moov’) . In this case, specific partial region information indicates only one combination (is fixed in a bitstream). Note that “packing_type=“0”” in the description example inside the square frame 502 in FIG. 34 indicates that the relationship between the position or size in the original picture 10 and the position or size in the partial region 121 is indicated by Region-wise packing in OMAF.

Even in a case where such Method 3-3 is applied, similarly to the case where Method 3-1 is applied, the client apparatus 113 can grasp a position of each of the subpictures 11 constituting the partial region 121 in the picture 10 by referring to the partial region information. Therefore, (the display information generation unit 184 of) the client apparatus 113 can correctly segment the segmented region 12 from the partial region 121 even in a case where the segmented region 12 relates to the plurality of subpictures 11 of the picture 10. That is, as the file generation apparatus 111 generates the partial region information as described above and provides the partial region information being stored in the MPD file to the client apparatus 113, (the display information generation unit 184 of) the client apparatus 113 can correctly segment the segmented region 12 from the partial region 121.

Note that Method 3-3 can be applied in a case where any one of Method 1-1-2, Method 1-1-3, Method 2-1-2, and Method 2-1-3 described above is applied.

### Flow of File Generation Processing

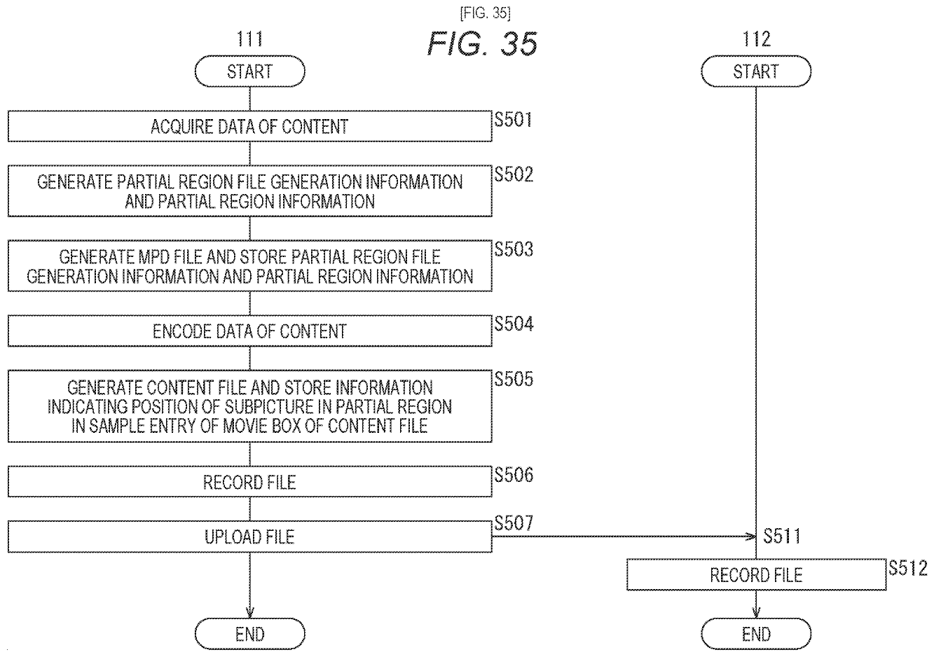

An example of a flow of processing (file generation processing) until the file generation apparatus 111 generates a file and uploads the file to the distribution server 112 in a case where the above-described Method 3-3 is applied will be described with reference to a flowchart of FIG. 35.

When the processing is started, the input unit 141 of the file generation apparatus 111 acquires data of content including a moving image in step S501.

In step S502, the preprocessing unit 142 generates partial region file generation information for generating a file that stores a bitstream of the partial region 121 of the picture 10 on the basis of the data of the moving image. Furthermore, the preprocessing unit 142 generates metadata for generating the bitstream of the partial region constituted by a subpicture on the basis of the data of the moving image. Moreover, the preprocessing unit 142 applies the above-described Method 3-3 to generate partial region information indicating a position of the subpicture 11 constituting the partial region 121 in the picture 10.

In step S503, the file generation unit 144 generates an MPD file which is a control file for controlling distribution of a content file, and stores the partial region file generation information generated in step S502 in the MPD file. Furthermore, the file generation unit 144 also stores the partial region information generated in step S502 in the MPD file by applying the above-described Method 3-3. As in the description example illustrated in FIG. 34, the partial region information includes information indicating a position of the subpicture 11 constituting a candidate for the partial region 121 in the picture 10. Furthermore, the partial region information may include link information with respect to information (a region-wise packing box) that is stored in the content file and indicates the position of the subpicture 11 in the partial region 121.

Furthermore, the file generation unit 144 generates a metadata file and stores the metadata generated in step S502 in the metadata file.

In step S504, the encoding unit 143 encodes the data of the content acquired in step S501 to generate a bitstream. For example, the encoding unit 143 encodes the data of the moving image by VVC to generate a bitstream of the picture 10.

In step S505, the file generation unit 144 generates a content file and stores a bitstream of the content generated in step S504. For example, the file generation unit 144 stores the bitstream of the picture 10 in the content file (VVC track). Furthermore, the file generation unit 144 may store the information indicating the position of the subpicture 11 in the partial region 121 in the content file by applying the above-described Method 3-3. For example, the file generation unit 144 may generate an MP4 file as a content file and store the region-wise packing box defined in OMAF in a sample entry of a movie box (‘moov’) .

Each process of steps S506 and S507 is executed similarly to each process of steps S106 and S107 of FIG. 9. Furthermore, each process of step S511 and step S512 is executed similarly to each process of step S111 and step S112 of FIG. 9.

Note that the flow of the content distribution processing in the case of applying the above-described Method 3-3 is similar to the case of applying Method 3-1 (FIG. 31).

As the respective processes are executed as described above, the file generation apparatus 111 can generate the partial region information, store the partial region information in the MPD file, and provide the MPD file to the client apparatus 113. Furthermore, the client apparatus 113 can acquire and store the MPD file. That is, the file generation apparatus 111 can provide the partial region information to the client apparatus 113. Furthermore, the client apparatus 113 can receive and decode the bitstream of the partial region 121 distributed from the distribution server 112. Then, the client apparatus 113 can segment the segmented region 12 from the partial region 121 on the basis of the partial region information stored in the stored MPD file.

Therefore, the client apparatus 113 can correctly segment the segmented region 12 on the basis of the partial region information.

### Modified Examples

Note that, in partial region information in a case where Method 3-3 is applied as described above, a position and a size of the subpicture 11 constituting each candidate for the partial region 121 in the picture 10 may be indicated using group_id of a trif sample group. That is, this group_id may be used instead of parameters such as region_top, region_left, region_height, and region_width. Furthermore, a position and a size of the subpicture 11 constituting each candidate for the partial region 121 in the picture 10 may be indicated using subpic_id of a spid sample group. That is, this subpic_id may be used instead of parameters such as region_top, region_left, region_height, and region_width.

Furthermore, a plurality of sample entries may be stored, and different region-wise packing boxes may be stored in advance. In this manner, it is also possible to cope with a case where the partial region 121 varies in the time direction.

### Method 3-4

In a case where Method 3 is applied, as illustrated in the lowermost part of the table illustrated in FIG. 27, a sample group indicating a correspondence relationship between a position (or size) in the picture 10 of the subpicture 11 constituting the partial region 121 and a position (or size) in the partial region 121 may be stored in a content file (VVC track). Then, partial region information stored in a control file (MPD file) may include link information (Method 3-4).

This sample group can be stored in a movie box (‘moov’) and a movie fragment box (‘moof’). Furthermore, in the sample group, meta information can be added to each sample. Therefore, it is possible to perform dynamic change for each time.

For example, the file generation unit 144 of the file generation apparatus 111 may further generate a content file and store the partial region information as the sample group in the content file. For example, the file generation unit 144 may store information indicating the position of each of the subpictures 11 constituting the partial region 121 in the picture 10 as the sample group in the movie box and the movie fragment box of the content file (MP4 file). Furthermore, the partial region information stored in the MPD file may further include link information with respect to the sample group.

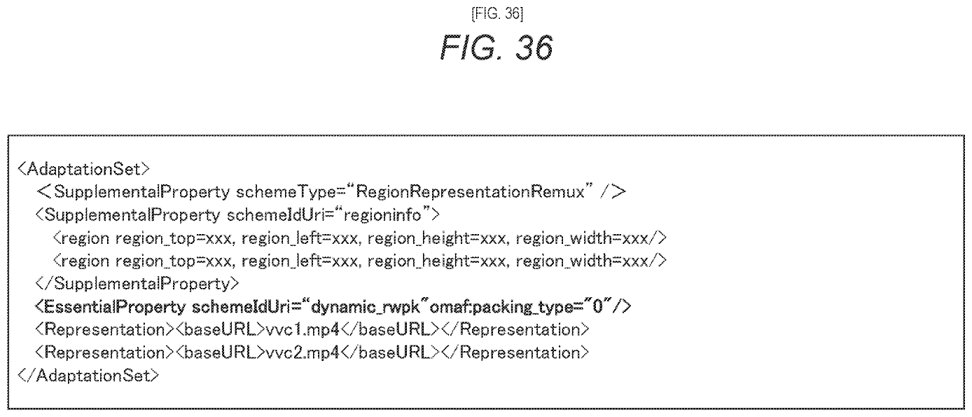

FIG. 36 is a view illustrating a description example of a part of the MPD file in that case. In this case, as illustrated in FIG. 36, information (region_top, region_left, region_height, region_width, and the like) indicating the position of the subpicture 11 in the picture 10 is stored in the MPD file. Furthermore, the link information with respect to the sample group stored in the content file is stored in the MPD file.

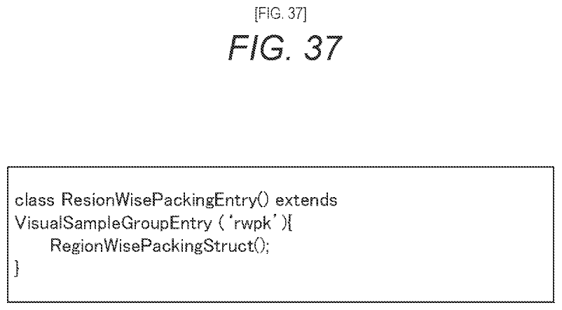

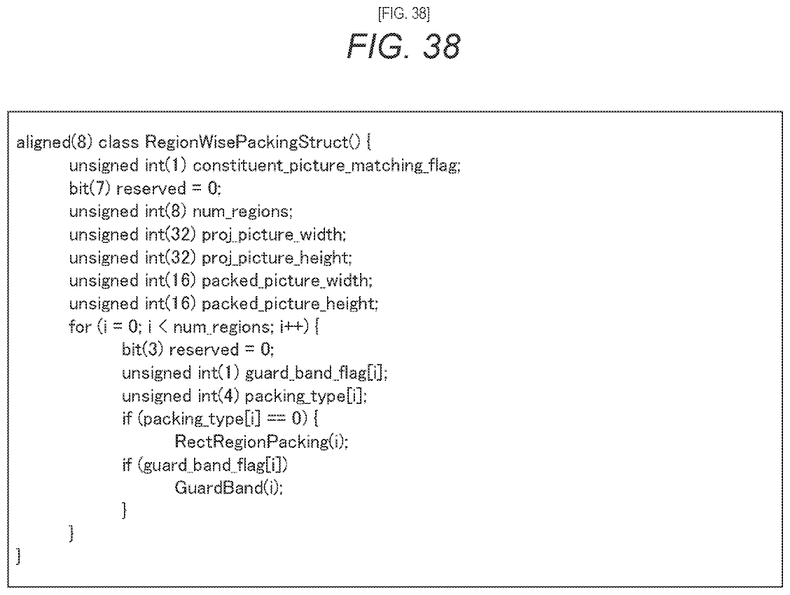

In the MP4 file, the sample group (for example, the sample group indicating the correspondence relationship between the position (or size) in the picture 10 and the position (or size) in the partial region 121 of the subpicture 11) of the partial region information is stored in the movie box (‘moov’) and the movie fragment box (‘moof’) . FIG. 37 illustrates a syntax example thereof. As illustrated in FIG. 37, in this case, RegionWisePackingStruct ( ) may be stored in a visual sample group entry. FIG. 38 illustrates a syntax example of RegionWisePackingStruct ( ).

Even in a case where such Method 3-4 is applied, similarly to the case where Method 3-1 is applied, the client apparatus 113 can grasp a position of each of the subpictures 11 constituting the partial region 121 in the picture 10 by referring to the partial region information. Therefore, (the display information generation unit 184 of) the client apparatus 113 can correctly segment the segmented region 12 from the partial region 121 even in a case where the segmented region 12 relates to the plurality of subpictures 11 of the picture 10. That is, as the file generation apparatus 111 generates the partial region information as described above and provides the partial region information being stored in the MPD file to the client apparatus 113, (the display information generation unit 184 of) the client apparatus 113 can correctly segment the segmented region 12 from the partial region 121.

Furthermore, in the case of Method 3-4, even in a case where the partial region 121 varies along the time axis, the partial region information can be stored in one adaptation set.

Note that Method 3-4 can be applied in a case where any one of Method 1-1-1 to Method 1-1-3, Method 2-1-1 to Method 2-1-3 described above is applied.

### Flow of File Generation Processing

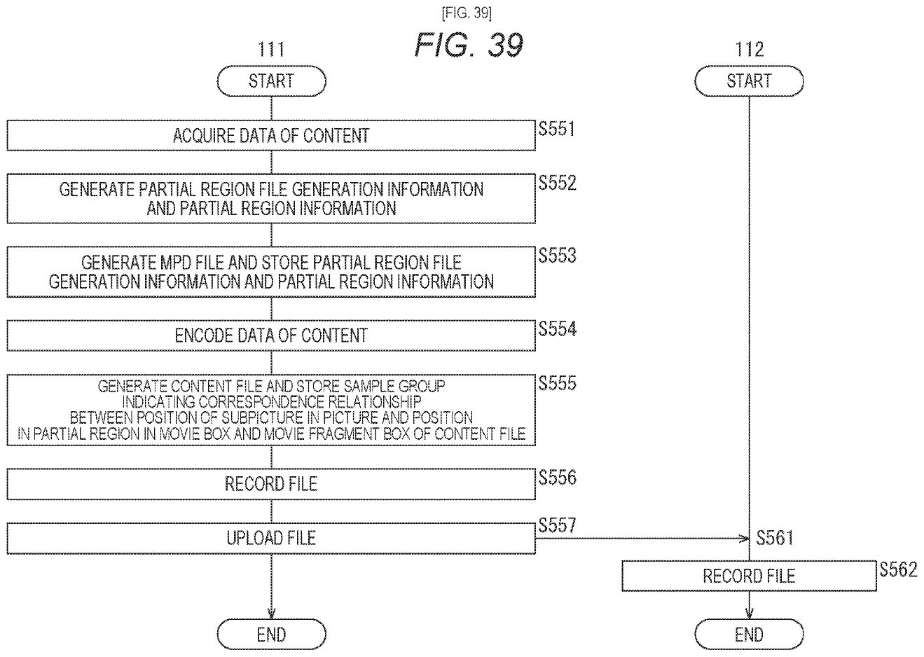

An example of a flow of processing (file generation processing) until the file generation apparatus 111 generates a file and uploads the file to the distribution server 112 in a case where the above-described Method 3-4 is applied will be described with reference to a flowchart of FIG. 39.

When the processing is started, the input unit 141 of the file generation apparatus 111 acquires data of content including a moving image in step S551.

In step S552, the preprocessing unit 142 generates partial region file generation information for generating a file that stores a bitstream of the partial region 121 of the picture 10 on the basis of the data of the moving image. Furthermore, the preprocessing unit 142 generates metadata for generating the bitstream of the partial region constituted by a subpicture on the basis of the data of the moving image. Moreover, the preprocessing unit 142 applies the above-described Method 3-4 to generate partial region information.

In step S553, the file generation unit 144 generates an MPD file which is a control file for controlling distribution of a content file, and stores the partial region file generation information generated in step S552 in the MPD file. Furthermore, the file generation unit 144 also stores the partial region information generated in step S552 in the MPD file by applying the above-described Method 3-4. The partial region information includes information indicating a position of the subpicture 11 constituting a candidate for the partial region 121 in the picture 10. Furthermore, the partial region information includes link information with respect to a sample group stored in a content file as described later.

Furthermore, the file generation unit 144 generates a metadata file and stores the metadata generated in step S552 in the metadata file.

In step S554, the encoding unit 143 encodes data of the content acquired in step S551 to generate a bitstream. For example, the encoding unit 143 encodes the data of the moving image by VVC to generate a bitstream of the picture 10.

In step S555, the file generation unit 144 generates a content file and stores a bitstream of the content generated in step S554. For example, the file generation unit 144 stores the bitstream of the picture 10 in the content file (VVC track). Furthermore, the file generation unit 144 stores, in the content file, the sample group indicating a correspondence relationship between a position (or size) in the picture 10 and a position (or size) in the partial region 121 of the subpicture 11 constituting the partial region 121 by applying the above-described Method 3-4. For example, the file generation unit 144 generates an MP4 file as the content file, and stores the sample group in a movie box (‘moov’) and a movie fragment box (‘moof’) of the MP4 file.

Each process of steps S556 and S557 is executed similarly to each process of steps S106 and S107 of FIG. 9. Furthermore, each process of step S561 and step S562 is executed similarly to each process of step S111 and step S112 of FIG. 9.

Note that the flow of the content distribution processing in the case of applying the above-described Method 3-4 is similar to the case of applying Method 3-1 (FIG. 31).

As the respective processes are executed as described above, the file generation apparatus 111 can generate the partial region information, store the partial region information in the MPD file, and provide the MPD file to the client apparatus 113. Furthermore, the client apparatus 113 can acquire and store the MPD file. That is, the file generation apparatus 111 can provide the partial region information to the client apparatus 113. Furthermore, the client apparatus 113 can receive and decode the bitstream of the partial region 121 distributed from the distribution server 112. Then, the client apparatus 113 can segment the segmented region 12 from the partial region 121 on the basis of the partial region information stored in the stored MPD file.

Therefore, the client apparatus 113 can correctly segment the segmented region 12 on the basis of the partial region information.

### Modified Examples

Note that RegionWisePackingStruct may be stored in SEI message of VVC. In this case, the client apparatus 113 analyzes a structure of a VVC stream in order to analyze a sample.

### 6. Supplementary Note

### Encoding/Decoding Method

Although the content (moving image) is encoded by VVC in the above description, this encoding/decoding method is not limited to VVC as long as a method enables division into one or more subpictures without decoding a bitstream of a picture.

### Computer

The above-described series of processing can be executed by hardware or software. In a case where the series of processing is executed by the software, a program that configures the software is installed in a computer. Here, the computer includes a computer incorporated in dedicated hardware, a general-purpose personal computer capable of executing various functions by installing various programs, and the like, for example.

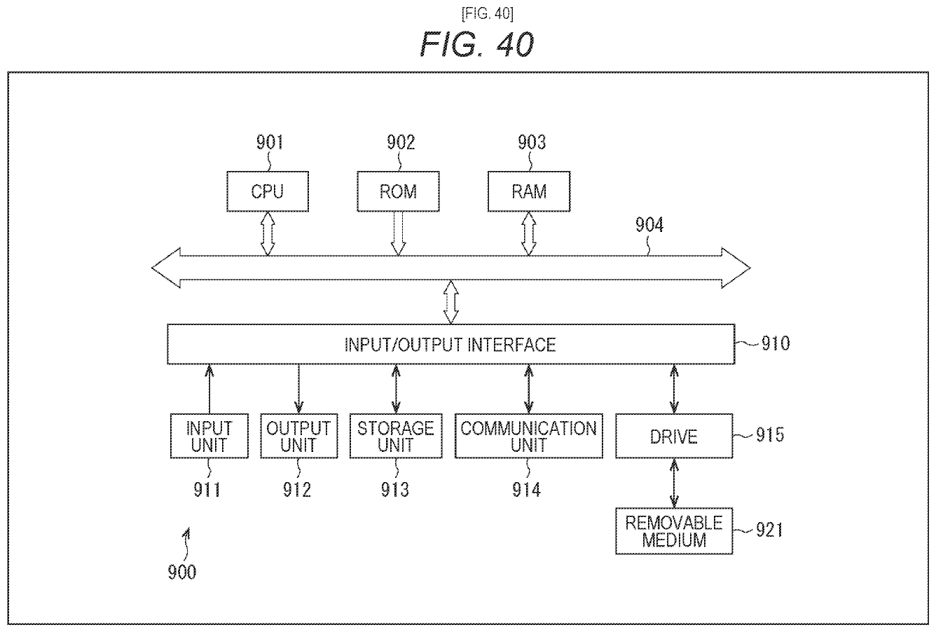

FIG. 40 is a block diagram illustrating a configuration example of hardware of a computer that executes the above-described series of processing with a program.

In a computer 900 illustrated in FIG. 40, a central processing unit (CPU) 901, a read only memory (ROM) 902, and a random access memory (RAM) 903 are mutually connected via a bus 904.

Furthermore, an input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a non-volatile memory and the like. The communication unit 914 includes, for example, a network interface. The drive 915 drives a removable medium 921 such as a magnetic disk, an optical disk, a magneto-optical disk, or a semiconductor memory.

In the computer configured as described above, the series of processing described above is executed, for example, by the CPU 901 loading a program stored in the storage unit 913 into the RAM 903 via the input/output interface 910 and the bus 904, and executing the program. Furthermore, the RAM 903 also appropriately stores data and the like necessary for the CPU 901 to execute various types of processing.

A program executed by the computer can be applied by being recorded on the removable medium 921 as a package medium, or the like, for example. In this case, the program can be installed in the storage unit 913 via the input/output interface 910 by attaching the removable medium 921 to the drive 915.

Furthermore, the program can also be provided via a wired or wireless transmission medium such as a local area network, the Internet, or digital satellite broadcasting. In this case, the program can be received by the communication unit 914 and installed in the storage unit 913.

Furthermore, this program can be installed in the ROM 902 or the storage unit 913 in advance.

### Applicable Target of Present Technology

The present technology may be applied to any configuration.

For example, the present technology can be applied to various electronic devices such as a transmitter and a receiver (for example, a television receiver and a mobile phone) in satellite broadcasting, cable broadcasting such as cable TV, distribution on the Internet, and distribution to a terminal by cellular communication, or a device (for example, a hard disk recorder and a camera) that records an image on a medium such as an optical disk, a magnetic disk, and a flash memory, or reproduces an image from the storage medium.

Furthermore, for example, the present technology can also be implemented as a partial configuration of an apparatus, such as a processor (for example, a video processor) as a system large scale integration (LSI) or the like, a module (for example, a video module) using a plurality of the processors or the like, a unit (for example, a video unit) using a plurality of the modules or the like, or a set (for example, a video set) obtained by further adding other functions to the unit.

Furthermore, for example, the present technology can also be applied to a network system including a plurality of apparatuses. For example, the present technology may be implemented as cloud computing shared and processed in cooperation by a plurality of apparatuses via a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (apparatuses, modules (parts), and the like), and it does not matter whether or not all the components are in the same housing. Therefore, both of a plurality of apparatuses stored in different housings and connected via a network, and one apparatus in which a plurality of modules is stored in one housing are systems.

### Field and Application to which Present Technology is Applicable

The system, apparatus, processing unit and the like to which the present technology is applied can be used in any field such as traffic, medical care, crime prevention, agriculture, livestock industry, mining, beauty care, factory, household appliance, weather, and natural surveillance, for example. Furthermore, application thereof is also arbitrary.

For example, the present technology can be applied to systems and devices used for providing content for appreciation and the like. Furthermore, for example, the present technology can also be applied to systems and devices used for traffic, such as traffic condition management and automated driving control. Moreover, for example, the present technology can also be applied to systems and devices used for security. Furthermore, for example, the present technology can be applied to systems and devices used for automatic control of a machine and the like. Moreover, for example, the present technology can also be applied to systems and devices provided for use in agriculture and livestock industry. Furthermore, the present technology can also be applied to systems and devices that monitor, for example, the status of nature such as a volcano, a forest, and the ocean, wildlife and the like. Moreover, for example, the present technology can also be applied to systems and devices used for sports.

### Others

Note that, in the present specification, a “flag” is information for identifying a plurality of states, and includes not only information used for identifying two states of true (1) and false (0) but also information capable of identifying three or more states. Therefore, a value that may be taken by the “flag” may be, for example, a binary of 1/0 or a ternary or more. That is, the number of bits forming this “flag” is any number, and may be one bit or a plurality of bits. Furthermore, identification information (including the flag) is assumed to include not only identification information thereof in a bitstream but also difference information of the identification information with respect to certain reference information in the bitstream, and thus, in the present specification, the “flag” and “identification information” include not only the information thereof but also the difference information with respect to the reference information.

Furthermore, various types of information (such as metadata) regarding coded data (bitstream) may be transmitted or recorded in any form as long as this is associated with the coded data. Herein, the term “associate” is intended to mean to make, when processing one data, the other data available (linkable), for example. That is, the data associated with each other may be collected as one data or may be made individual data. For example, information associated with the coded data (image) may be transmitted on a transmission path different from that of the coded data (image). Furthermore, for example, the information associated with the coded data (image) may be recorded in a recording medium different from that of the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “integrate”, “include”, “store”, “put in”, “introduce”, and “insert” mean, for example, to combine a plurality of objects into one, such as to combine coded data and metadata into one data, and mean one method of “associating” described above.

Furthermore, the embodiments of the present technology are not limited to the above-described embodiments, and various modifications are possible without departing from the scope of the present technology.

For example, a configuration described as one apparatus (or processing unit) may be divided and configured as a plurality of apparatuses (or processing units). Conversely, configurations described above as a plurality of apparatuses (or processing units) may be collectively configured as one apparatus (or processing unit). Furthermore, a configuration other than the above-described configurations may be added to the configuration of each apparatus (or individual processing unit). Moreover, if the configuration and operation of the entire system are substantially the same, a part of the configuration of a certain apparatus (or processing unit) may be included in the configuration of another apparatus (or another processing unit).

Furthermore, for example, the above-described program may be executed in any apparatus. In this case, the apparatus is only required to have a necessary function (functional block and the like) and obtain necessary information.

Furthermore, for example, each step in one flowchart may be executed by one apparatus, or may be executed by being shared by a plurality of apparatuses. Moreover, in a case where a plurality of processes is included in one step, the plurality of processes may be executed by one device, or may be shared and executed by a plurality of devices. In other words, the plurality of processes included in the one step can also be executed as processes of a plurality of steps. Conversely, the processes described as the plurality of the steps can also be collectively executed as one step.

Furthermore, the program executed by the computer may have the following features. For example, the processes of the steps describing the program may be executed in time series in the order described in the present specification. Furthermore, the processes of the steps describing the program may be executed in parallel. Moreover, the processes of the steps describing the program may be individually executed at the necessary timing, such as when the program is called. That is, the processes of the respective steps may be executed in an order different from the above-described order as long as there is no contradiction. Furthermore, the processes of the steps describing this program may be executed in parallel with processes of another program. Moreover, the processes of the steps describing this program may be executed in combination with processes of another program.

Furthermore, for example, a plurality of technologies related to the present technology can be implemented independently as a single entity as long as there is no contradiction. Of course, a plurality of arbitrary present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that the present technology can also have the following configurations.
(1) An image processing system including a server and a client apparatus, in which
the client apparatus
requests the server for a bitstream of a partial region of a picture on the basis of partial region file generation information included in a control file for controlling distribution of a content file to generate a file for storing the bitstream of the partial region,
the server
generates the bitstream of the partial region constituted by some of subpictures among the subpictures included in the picture on the basis of the request by the client apparatus, and
transmits the bitstream of the partial region to the client apparatus, and
the client apparatus
receives the bitstream of the partial region transmitted from the server, and
segments a segmented region from the bitstream of the partial region.
(2) An image processing apparatus including:
a generation unit that generates a bitstream of a partial region constituted by some of subpictures among the subpictures included in a picture on the basis of a request from another apparatus; and
a transmission unit that transmits a bitstream of the partial region to the another apparatus.
(3) The image processing apparatus according to (2), in which
the generation unit extracts the subpictures constituting the partial region from a bitstream of the picture on the basis of the request, and generates a bitstream of the partial region.
(4) The image processing apparatus according to (3), in which
the generation unit identifies a subpicture including a segmented region designated using a coordinate in the request, selects metadata from which the identified subpicture is extractable, extracts the identified subpicture from the bitstream of the picture using the selected metadata, and generates a bitstream of the partial region constituted by the extracted subpicture.
(5) The image processing apparatus according to (4), in which
the generation unit
generates a bitstream of the partial region in a case where a bitstream of the subpicture is requested, and
decodes the bitstream of the picture and segments the segmented region from the picture and encodes the segmented region to generate a bitstream of the segmented region in a case where the bitstream of the segmented region is requested.
(6) The image processing apparatus according to (3), in which
the generation unit identifies a subpicture including a segmented region designated using information regarding a display region in the request, selects metadata from which the identified subpicture is extractable, extracts the identified subpicture from the bitstream of the picture using the selected metadata, and generates a bitstream of the partial region constituted by the extracted subpicture.
(7) The image processing apparatus according to (3), in which
the generation unit selects metadata from which a subpicture constituting the partial region designated using identification information in the request is extractable, extracts the subpicture from the bitstream of the picture using the selected metadata, and generates a bitstream of the partial region constituted by the extracted subpicture.
(8) The image processing apparatus according to (3), in which
the generation unit selects metadata from which a subpicture designated using identification information in the request is extractable, extracts the subpicture from the bitstream of the picture using the selected metadata, and generates a bitstream of the partial region constituted by the extracted subpicture.
(9) The image processing apparatus according to (3), in which
the generation unit selects metadata from which a subpicture constituting a partial region designated using identification information defined in a control file for controlling distribution of a content file is extractable, extracts the subpicture from the bitstream of the picture using the selected metadata, and generates a bitstream of the partial region.
(10) The image processing apparatus according to (3), in which
the generation unit selects metadata from which a subpicture constituting a partial region, designated in the request among partial regions defined as an adaptation set in a control file for controlling distribution of a content file, is extractable, extracts the subpicture from the bitstream of the picture using the selected metadata, and generates a bitstream of the designated partial region.
(11) The image processing apparatus according to (3), in which
the generation unit uses metadata for extracting a subpicture designated in the request to extract the subpicture from the bitstream of the picture, and generates a bitstream of the partial region constituted by the extracted subpicture.
(12) The image processing apparatus according to (2), in which
the generation unit merges bitstreams of the subpictures constituting the partial region on the basis of the request and generates a bitstream of the partial region.
(13) The image processing apparatus according to (12), in which
the generation unit identifies subpictures including a segmented region designated using a coordinate in the request, selects metadata capable of merging the identified subpictures, merges the identified subpictures using the selected metadata, and generates a bitstream of the partial region constituted by the merged subpictures.
(14) The image processing apparatus according to (13), in which
the generation unit
generates a bitstream of the partial region in a case where a bitstream of the subpicture is requested, and
decodes the bitstream of the picture and segments the segmented region from the picture and encodes the segmented region to generate a bitstream of the segmented region in a case where the bitstream of the segmented region is requested.
(15) The image processing apparatus according to (12), in which
the generation unit identifies subpictures including a segmented region designated using information regarding a display region in the request, selects metadata capable of merging the identified subpictures, merges bitstreams of the identified subpictures using the selected metadata, and generates a bitstream of the partial region constituted by the merged subpictures.
(16) The image processing apparatus according to (12), in which
the generation unit selects metadata capable of merging subpictures constituting the partial region designated using identification information in the request, merges the subpictures using the selected metadata, and generates a bitstream of the partial region constituted by the merged subpictures.
(17) The image processing apparatus according to (12), in which
the generation unit selects metadata capable of merging subpictures constituting a partial region designated using identification information defined in a control file for controlling distribution of a content file, and merges the subpictures using the selected metadata, and generates a bitstream of the partial region.
(18) The image processing apparatus according to (12), in which
the generation unit selects metadata capable of merging subpictures constituting a partial region, designated in the request among partial regions defined as an adaptation set in a control file for controlling distribution of a content file, merges the subpictures using the selected metadata, and generates a bitstream of the designated partial region.
(19) The image processing apparatus according to (12), in which
the generation unit merges subpictures using metadata for merging the subpictures designated in the request, and generates a bitstream of the partial region constituted by the merged subpictures.
(20) An image processing method including:
generating a bitstream of a partial region constituted by some of subpictures among the subpictures included in a picture on the basis of a request from another apparatus; and
transmitting the bitstream of the partial region to the another apparatus.
(31) An image processing apparatus including:
a partial region file generation information generation unit that generates, on the basis of data of content, partial region file generation information for generating a file for storing a bitstream of a partial region of a picture; and
a file generation unit that generates a control file for controlling distribution of a content file to store the partial region file generation information.
(32) The image processing apparatus according to (31), in which
the partial region file generation information includes information indicating that the bitstream of the partial region can be generated in a server that distributes the content file.
(33) The image processing apparatus according to (32), in which
the partial region file generation information includes information designating a type of information that can be processed by the server.
(34) The image processing apparatus according to any one of (31) to (33), in which
the file generation unit stores the partial region file generation information in an adaptation set corresponding to a bitstream of the picture.
(35) The image processing apparatus according to any one of (31) to (33), in which
the file generation unit stores the partial region file generation information in an adaptation set corresponding to metadata for extracting a subpicture.
(36) The image processing apparatus according to any one of (31) to (33), in which
the file generation unit stores the partial region file generation information in an adaptation set corresponding to metadata for merging subpictures.
(37) The image processing apparatus according to (31), in which
the partial region file generation information generation unit further generates partial region information indicating a position of a subpicture constituting the partial region in the picture, and
the file generation unit stores the partial region information in the control file.
(38) The image processing apparatus according to (37), in which
the file generation unit stores pieces of the partial region information of candidates for the partial region in mutually different adaptation sets of the control file.
(39) The image processing apparatus according to (37) or (38), in which
the partial region information further includes information indicating a position of the subpicture in the partial region.
(40) The image processing apparatus according to any one of (37) to (39), in which
the partial region information further includes information indicating a size of the subpicture.
(41) The image processing apparatus according to any one of (37) to (40), in which
the file generation unit stores pieces of the partial region information of candidates for the partial region in one adaptation set of the control file.
(42) The image processing apparatus according to any one of (37) to (41), in which
the partial region information further includes link information with respect to information indicating a position of the subpicture in the partial region.
(43) The image processing apparatus according to (42), in which
the file generation unit further generates the content file, and stores the information indicating the position of the subpicture in the partial region in a sample entry of a movie box of the content file.
(44) The image processing apparatus according to any one of (37) to (43), in which
the partial region information further includes link information with respect to the partial region information.
(45) The image processing apparatus according to (44), in which
the file generation unit further generates the content file, and stores the partial region information as a sample group in a movie fragment box of the content file.
(46) An image processing method including:
generating partial region file generation information for generating a file for storing a bitstream of a partial region of a picture on the basis of data of content; and
generating a control file for controlling distribution of a content file to store the partial region file generation information.
(51) An image processing apparatus including:
a request processing unit that makes a request for a bitstream of a partial region of a picture on the basis of partial region file generation information included in a control file for controlling distribution of a content file to generate a file for storing the bitstream of the partial region;
an acquisition unit that acquires the bitstream of the partial region; and
a segmentation unit that segments a segmented region from the bitstream of the partial region.
(52) The image processing apparatus according to (51), in which
the segmentation unit segments the segmented region on the basis of partial region information that is included in the control file and indicates a position in the picture of a subpicture constituting the partial region.
(53) An image processing method including: making a request for a bitstream of a partial region of a picture on the basis of partial region file generation information included in a control file for controlling distribution of a content file to generate a file for storing the bitstream of the partial region;
acquiring the bitstream of the partial region; and
segmenting a segmented region from the bitstream of the partial region.

### REFERENCE SIGNS LIST

100 Content distribution system
110 Network
111 File generation apparatus
112 Distribution server
113 Client apparatus
131 Control unit
132 File generation processing unit
141 Input unit
142 Preprocessing unit
143 Encoding unit
144 File generation unit
145 Recording unit
146 Output unit
151 Communication unit
152 Storage unit
153 Generation unit
171 Control unit
172 Client processing unit
181 File acquisition unit
182 File processing unit
183 Decoding unit
184 Display information generation unit
185 Display unit
186 Display control unit
900 Computer

1. An image processing system comprising a server and a client apparatus, wherein
the client apparatus
requests the server for a bitstream of a partial region of a picture on a basis of partial region file generation information included in a control file for controlling distribution of a content file to generate a file for storing the bitstream of the partial region,
the server
generates the bitstream of the partial region constituted by some of subpictures among the subpictures included in the picture on a basis of the request by the client apparatus, and
transmits the bitstream of the partial region to the client apparatus, and
the client apparatus
receives the bitstream of the partial region transmitted from the server, and
segments a segmented region from the bitstream of the partial region.

2. An image processing apparatus comprising:
a generation unit that generates a bitstream of a partial region constituted by some of subpictures among the subpictures included in a picture on a basis of a request from another apparatus; and
a transmission unit that transmits a bitstream of the partial region to the another apparatus.

3. The image processing apparatus according to claim 2, wherein
the generation unit extracts the subpictures constituting the partial region from a bitstream of the picture on a basis of the request, and generates a bitstream of the partial region.

4. The image processing apparatus according to claim 3, wherein
the generation unit identifies a subpicture including a segmented region designated using a coordinate in the request, selects metadata from which the identified subpicture is extractable, extracts the identified subpicture from the bitstream of the picture using the selected metadata, and generates a bitstream of the partial region constituted by the extracted subpicture.

5. The image processing apparatus according to claim 4, wherein
the generation unit
generates a bitstream of the partial region in a case where a bitstream of the subpicture is requested, and
decodes the bitstream of the picture and segments the segmented region from the picture and encodes the segmented region to generate a bitstream of the segmented region in a case where the bitstream of the segmented region is requested.

6. The image processing apparatus according to claim 3, wherein
the generation unit identifies a subpicture including a segmented region designated using information regarding a display region in the request, selects metadata from which the identified subpicture is extractable, extracts the identified subpicture from the bitstream of the picture using the selected metadata, and generates a bitstream of the partial region constituted by the extracted subpicture.

7. The image processing apparatus according to claim 3, wherein
the generation unit selects metadata from which a subpicture constituting the partial region designated using identification information in the request is extractable, extracts the subpicture from the bitstream of the picture using the selected metadata, and generates a bitstream of the partial region constituted by the extracted subpicture.

8. The image processing apparatus according to claim 3, wherein
the generation unit selects metadata from which a subpicture designated using identification information in the request is extractable, extracts the subpicture from the bitstream of the picture using the selected metadata, and generates a bitstream of the partial region constituted by the extracted subpicture.

9. The image processing apparatus according to claim 3, wherein
the generation unit selects metadata from which a subpicture constituting a partial region designated using identification information defined in a control file for controlling distribution of a content file is extractable, extracts the subpicture from the bitstream of the picture using the selected metadata, and generates a bitstream of the partial region.

10. The image processing apparatus according to claim 3, wherein
the generation unit selects metadata from which a subpicture constituting a partial region, designated in the request among partial regions defined as an adaptation set in a control file for controlling distribution of a content file, is extractable, extracts the subpicture from the bitstream of the picture using the selected metadata, and generates a bitstream of the designated partial region.

11. The image processing apparatus according to claim 3, wherein
the generation unit uses metadata for extracting a subpicture designated in the request to extract the subpicture from the bitstream of the picture, and generates a bitstream of the partial region constituted by the extracted subpicture.

12. The image processing apparatus according to claim 2, wherein
the generation unit merges bitstreams of the subpictures constituting the partial region on a basis of the request and generates a bitstream of the partial region.

13. The image processing apparatus according to claim 12, wherein
the generation unit identifies subpictures including a segmented region designated using a coordinate in the request, selects metadata capable of merging the identified subpictures, merges the identified subpictures using the selected metadata, and generates a bitstream of the partial region constituted by the merged subpictures.

14. The image processing apparatus according to claim 13, wherein
the generation unit
generates a bitstream of the partial region in a case where a bitstream of the subpicture is requested, and
decodes the bitstream of the picture and segments the segmented region from the picture and encodes the segmented region to generate a bitstream of the segmented region in a case where the bitstream of the segmented region is requested.

15. The image processing apparatus according to claim 12, wherein
the generation unit identifies subpictures including a segmented region designated using information regarding a display region in the request, selects metadata capable of merging the identified subpictures, merges bitstreams of the identified subpictures using the selected metadata, and generates a bitstream of the partial region constituted by the merged subpictures.

16. The image processing apparatus according to claim 12, wherein
the generation unit selects metadata capable of merging subpictures constituting the partial region designated using identification information in the request, merges the subpictures using the selected metadata, and generates a bitstream of the partial region constituted by the merged subpictures.

17. The image processing apparatus according to claim 12, wherein
the generation unit selects metadata capable of merging subpictures constituting a partial region designated using identification information defined in a control file for controlling distribution of a content file, and merges the subpictures using the selected metadata, and generates a bitstream of the partial region.

18. The image processing apparatus according to claim 12, wherein
the generation unit selects metadata capable of merging subpictures constituting a partial region, designated in the request among partial regions defined as an adaptation set in a control file for controlling distribution of a content file, merges the subpictures using the selected metadata, and generates a bitstream of the designated partial region.

19. The image processing apparatus according to claim 12, wherein
the generation unit merges subpictures using metadata for merging the subpictures designated in the request, and generates a bitstream of the partial region constituted by the merged subpictures.

20. An image processing method comprising:
generating a bitstream of a partial region constituted by some of subpictures among the subpictures included in a picture on a basis of a request from another apparatus; and
transmitting the bitstream of the partial region to the another apparatus.

21. An image processing apparatus comprising:
a partial region file generation information generation unit that generates, on a basis of data of content, partial region file generation information for generating a file for storing a bitstream of a partial region of a picture; and
a file generation unit that generates a control file for controlling distribution of a content file to store the partial region file generation information.

22. The image processing apparatus according to claim 21, wherein
the partial region file generation information generation unit further generates partial region information indicating a position of a subpicture constituting the partial region in the picture, and
the file generation unit stores the partial region information in the control file.

23. The image processing apparatus according to claim 22, wherein
the file generation unit stores pieces of the partial region information of candidates for the partial region in mutually different adaptation sets of the control file.

24. The image processing apparatus according to claim 22, wherein
the partial region information further includes information indicating a position of the subpicture in the partial region.

25. The image processing apparatus according to claim 22, wherein
the partial region information further includes information indicating a size of the subpicture.

26. The image processing apparatus according to claim 22, wherein
the file generation unit stores pieces of the partial region information of candidates for the partial region in one adaptation set of the control file.

27. The image processing apparatus according to claim 22, wherein
the partial region information further includes link information with respect to information indicating a position of the subpicture in the partial region.

28. The image processing apparatus according to claim 27, wherein
the file generation unit further generates the content file, and stores the information indicating the position of the subpicture in the partial region in a sample entry of a movie box of the content file.

29. The image processing apparatus according to claim 22, wherein
the partial region information further includes link information with respect to the partial region information.

30. The image processing apparatus according to claim 29, wherein
the file generation unit further generates the content file, and stores the partial region information as a sample group in a movie fragment box of the content file.

31. An image processing method comprising:
generating partial region file generation information for generating a file for storing a bitstream of a partial region of a picture on a basis of data of content; and
generating a control file for controlling distribution of a content file to store the partial region file generation information.

32. An image processing apparatus comprising:
a request processing unit that makes a request for a bitstream of a partial region of a picture on a basis of partial region file generation information included in a control file for controlling distribution of a content file to generate a file for storing the bitstream of the partial region;
an acquisition unit that acquires the bitstream of the partial region; and
a segmentation unit that segments a segmented region from the bitstream of the partial region.

33. The image processing apparatus according to claim 32, wherein
the segmentation unit segments the segmented region on a basis of partial region information that is included in the control file and indicates a position in the picture of a subpicture constituting the partial region.

34. An image processing method comprising:
making a request for a bitstream of a partial region of a picture on a basis of partial region file generation information included in a control file for controlling distribution of a content file to generate a file for storing the bitstream of the partial region;
acquiring the bitstream of the partial region; and
segmenting a segmented region from the bitstream of the partial region.
